(19) United States
(12) Patent Application Publication
(10) Pub. No.: US 2022/0078775 A1
(43) Pub. Date: Mar. 10, 2022

(54) COMMUNICATION APPARATUS AND COMMUNICATION METHOD

(71) Applicant: SONY GROUP CORPORATION, TOKYO (JP)

(72) Inventor: SAWAKO KIRIYAMA, TOKYO (JP)

(21) Appl. No.: 17/417,354

(22) PCT Filed: Nov. 19, 2019
(86) PCT No.: PCT/JP2019/045326

§ 371 Date: Jun. 22, 2021

(30) Foreign Application Priority Data
Jan. 7, 2019 (JP) 2019-000872

(51) Int. Cl. H04W 72/04

(52) U.S. Cl. CPC H04W 72/044; H04W 4/38; H04W 72/0406

(57) ABSTRACT

There is provided a communication apparatus which transmits and receives a wireless frame in an asymmetric communication system.

The communication apparatus gives a notification of information associated with a wireless resource to be used for data frame transmission using a control frame. The control frame contains information for time synchronization, and information associated with a data frame transmission time. Alternatively, the control frame may contain information which designates a wireless resource used by an own terminal and also another terminal for data frame transmission, and further contain information associated with a data frame transmission period, and the number of times of data frame transmission using the wireless resource designated by the control frame.

### TECHNICAL FIELD

A technology disclosed in the present specification relates to a communication apparatus and a communication method for transmitting and receiving a wireless frame.

### BACKGROUND ART

Creation of new services is achievable by using a wireless sensor network which regularly transmits information acquired from a sensor of a wireless sensor terminal given to a human or an object. For example, a watching service is providable by attaching a wireless sensor terminal having a GPS (Global Positioning System) function to an old person or a child, and regularly transmitting position information from the wireless sensor terminal.

For example, there has been proposed a sensor network system including a sensor master device which receives detection information obtained by a sensor and received via wireless communication, a data server which acquires the detection information from the sensor master device, and a notification device which receives notification information from the data server and issues a notification. According to this sensor network system, a notification target is determined by the data server on the basis of a detected position indicated by the detection information, and a notification corresponding to the detection information is given to the notification target (see PTL 1).

### CITATION LIST

### Patent Literature

### [PTL 1]

Japanese Patent Laid-open No. 2017-68612

### SUMMARY

### Technical Problem

An object of the technology disclosed in the present specification is to provide a communication apparatus and a communication method for transmitting and receiving a wireless frame within a wireless communication system which may contain a considerable number of terminals, such as a wireless sensor network.

### Solution to Problem

A first aspect of the technology disclosed in the present specification is directed to a communication apparatus including a communication unit that transmits and receives a wireless signal, and a control unit that controls frame transmission and reception performed by the communication unit. The control unit performs such a control as to give, using a control frame, a notification of information associated with a wireless resource to be used for transmission of a data frame.

The control unit performs such a control as to transmit a control frame that contains the information including time information to be used for time synchronization. In addition, the control unit performs such a control as to transmit a control frame that further contains the information associated with a transmission time of the data frame.

Alternatively, the control unit performs such a control as to transmit a control frame that further contains the information indicating a wireless resource to be used for transmission of the data frame. In addition, the control unit may perform such a control as to transmit a control frame that further contains information associated with a transmission period of the data frame, and number of times of transmission of the data frame using the wireless resource indicated by the control frame.

Moreover, a second aspect of the technology disclosed in the present specification is directed to a communication method including a step of transmitting a control frame containing information associated with a wireless resource to be used for transmission of a data frame; and a step of transmitting the data frame using the wireless resource.

Further, a third aspect of the technology disclosed in the present specification is directed to a communication apparatus including a communication unit that transmits and receives a wireless signal, and a control unit that controls frame transmission and reception performed by the communication unit. The control unit acquires, from a received control frame, information associated with a wireless resource used by a transmission source of the control frame for transmission of a data frame, and determines a wireless resource to be used for transmission of the data frame.

In addition, a fourth aspect of the technology disclosed in the present specification is directed to a communication method including a step of receiving a control frame containing information associated with a wireless resource to be used for transmission of a data frame, and a step of determining the wireless resource used for transmission of the data frame on the basis of the information acquired from the control frame, and transmits the data frame.

Moreover, a fifth aspect of the technology disclosed in the present specification is directed to a communication apparatus including a communication unit that transmits and receives a wireless signal, and a control unit that controls frame transmission and reception performed by the communication unit. The control unit acquires, from a received control frame, information associated with a wireless resource to be used for transmission of a data frame by a second terminal having transmitted the control frame, and determines a wireless resource for which a reception process for receiving the data frame from the second terminal is performed.

Moreover, a sixth aspect of the technology disclosed in the present specification is directed to a communication method including a step of receiving a control frame containing information associated with a wireless resource to be used for transmission of a data frame, and a step of performing a reception process for receiving the data frame on the basis of the information acquired from the control frame.

### Advantageous Effects of Invention

Providable by the technology disclosed in the present specification is a communication apparatus and a communication method each autonomously determining a wireless resource to be used and transmitting a wireless frame within a wireless communication system which may contain a considerable number of terminals, such as a wireless sensor network.

Note that advantageous effects described in the present specification are presented only by way of example. Advantageous effects of the present invention are not limited to those. Moreover, the present invention may further offer additional advantageous effects as well as the advantageous effects described above.

Other purposes, characteristics, and advantages of the technology disclosed in the present specification will become apparent in the light of more detailed explanation based on embodiments described below and accompanying drawings.

### BRIEF DESCRIPTION OF DRAWINGS

FIG. 1 is a diagram depicting an example of a wireless communication system.

FIG. 2 is a diagram depicting a configuration example of a communication apparatus 100 operating as a terminal.

FIG. 3 is a diagram depicting a frame configuration example.

FIG. 4 is a diagram depicting an outline of a wireless resource.

FIG. 5 is a diagram depicting a pseudorandom number generator used for determination of a transmission time.

FIG. 6 is a diagram depicting a pseudorandom number generator used for generation of a SYNC code.

FIG. 7 is a diagram depicting a pseudorandom number generator used for generation of a scramble code.

FIG. 8 is a diagram depicting a configuration example of a communication apparatus 200 operating as a base station.

FIG. 9 is a diagram presenting a communication sequence example of a wireless communication system according to a first embodiment.

FIG. 10 is a flowchart presenting a processing procedure performed by a terminal for acquiring time information from a control frame.

FIG. 11 is a flowchart presenting a processing procedure performed by a terminal for transmitting a control frame and a data frame.

FIG. 12 is a flowchart presenting a processing procedure performed by a base station for receiving a control frame.

FIG. 13 is a flowchart presenting a processing procedure performed by the base station for receiving a data frame.

FIG. 14 is a diagram depicting an example of a wireless communication system assumed in a second embodiment.

FIG. 15 is a diagram depicting a configuration example (second embodiment) of the communication apparatus 100 operating as a terminal.

FIG. 16 is a diagram depicting a configuration example of a communication apparatus 200 (second embodiment) operating as a base station.

FIG. 17 is a diagram depicting an outline of a wireless resource.

FIG. 18 is a diagram presenting a communication sequence example of a wireless communication system according to the second embodiment.

FIG. 19 is a flowchart presenting a processing procedure performed by a terminal for acquiring time information from a DL beacon frame.

FIG. 20 is a flowchart presenting a processing procedure performed by a base station for transmitting a DL beacon frame.

FIG. 21 is a diagram depicting a frame configuration example (third embodiment) of a DATA portion of a control frame.

FIG. 22 is a diagram depicting a state of transmission of a control frame and a data frame.

FIG. 23 is a diagram depicting a configuration example (fourth embodiment) of the communication apparatus 100 operating as a terminal.

FIG. 24 is a diagram depicting a configuration example of a combination database of initial values used for generation of a SYNC code and a scramble code.

FIG. 25 is a diagram depicting a configuration example (fourth embodiment) of a wireless resource use schedule database.

FIG. 26 is a diagram depicting a frame configuration example (fourth embodiment) of a DATA portion of a control frame.

FIG. 27 is a diagram depicting a configuration example of the communication apparatus 200 (fourth embodiment) operating as a base station.

FIG. 28A is a flowchart presenting a processing procedure (first half) for determining a wireless resource used for transmission of a data frame.

FIG. 28B is a flowchart presenting a processing procedure (second half) for determining a wireless resource used for transmitting a data frame.

FIG. 29 is a diagram presenting a communication sequence example of a wireless communication system according to the fourth embodiment.

FIG. 30 is a flowchart presenting a processing procedure performed by a terminal for acquiring wireless resource information scheduled to be used by another terminal.

FIG. 31 is a flowchart presenting a processing procedure performed by a terminal for transmitting a control frame and a data frame.

FIG. 32 is a flowchart presenting a processing procedure performed by a base station for receiving a control frame from a terminal.

FIG. 33 is a flowchart presenting a processing procedure performed by a base station for receiving a data frame from a terminal from a terminal.

FIG. 34 is a diagram depicting a frame configuration example (fifth embodiment) of a DATA portion of a control frame.

FIG. 35 is a diagram depicting an example of a wireless communication system assumed in the fifth embodiment.

FIG. 36 is a diagram presenting a communication sequence example (first half) of a wireless communication system according to the fifth embodiment.

FIG. 37 is a diagram presenting a communication sequence example (second half) of a wireless communication system according to the fifth embodiment.

FIG. 38 is a diagram depicting a configuration example of the communication apparatus 200 (sixth embodiment) operating as a base station.

FIG. 39 is a diagram depicting a frame configuration example (sixth embodiment) of a DATA portion of a control frame.

FIG. 40 is a diagram presenting a communication sequence example of a wireless communication system according to the sixth embodiment.

FIG. 41 is a flowchart presenting a processing procedure performed by a terminal for synchronizing a wireless resource use schedule database using a DL beacon frame.

FIG. 42 is a flowchart presenting a processing procedure for receiving a control frame from another terminal.

FIG. 43 is a diagram depicting a frame configuration example (seventh embodiment) of a DATA portion of a control frame.

FIG. 44 is a diagram depicting a configuration example (seventh embodiment) of a wireless resource use schedule database.

FIG. 45 is a flowchart presenting a processing procedure performed by a base station for receiving a control frame.

FIG. 46 is a diagram depicting an example of an asymmetric communication system where a receivable range of a base station is different from a receivable range of a terminal.

### DESCRIPTION OF EMBODIMENTS

Embodiments of the technology disclosed in the present specification will be hereinafter described in detail with reference to the drawings.

According to a wireless communication system assumed to contain a considerable number of terminals, such as a wireless sensor network, one base station needs to receive data transmitted from a large number of terminals. For meeting this requirement, it is essential to adopt a method for avoiding a collision between transmission frames of the respective terminals, or a method for separating the respective frames on the reception side at the time of a collision. Examples of the former method for avoiding a collision include a method which transmits frames by time sharing or frequency sharing. In addition, the latter method for separating collision frames is achievable by code multiplexing such as scramble coding.

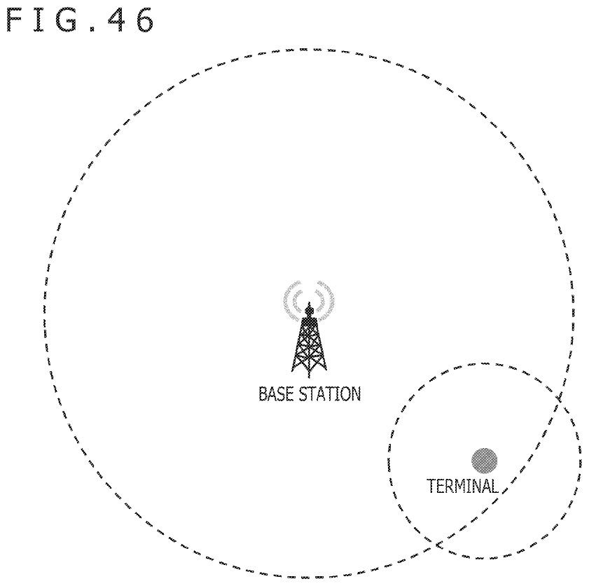

According to a wireless communication system such as LTE (Long Term Evolution), a terminal communicates with a base station by signaling beforehand, and transmits a frame using a wireless resource (time, frequency, and codes) allocated by the base station to achieve the above. However, in a case of an asymmetric wireless communication system where a receivable range of a base station is different from a receivable range of a terminal, a terminal located far from a base station as depicted in FIG. 46 is unable to receive downlink (DL) communication from the base station to the terminal. Accordingly, there arises such a problem that an allocation of a wireless resource from the base station is difficult to be receive by the terminal. For example, in a case where a wireless sensor network is constructed using LPWA (Low Power, Wide Area) technology to increase a use period of a battery-driven-type terminal, a receivable range of each terminal decreases. In this case, an asymmetric system may be produced.

Accordingly, hereinafter proposed in the present specification will be such a technology where a terminal estimates a wireless resource allowing avoidance of a collision with another terminal and allowing separation, and autonomously determines a wireless resource used for frame transmission on the basis of control frame information transmitted from a near terminal.

### Embodiment 1

Assumed in a first embodiment is a system which achieves time synchronization in an entire wireless communication system, and determines a wireless resource (time, frequency, and codes) used for transmission by using a time as a common random value within the wireless communication system.

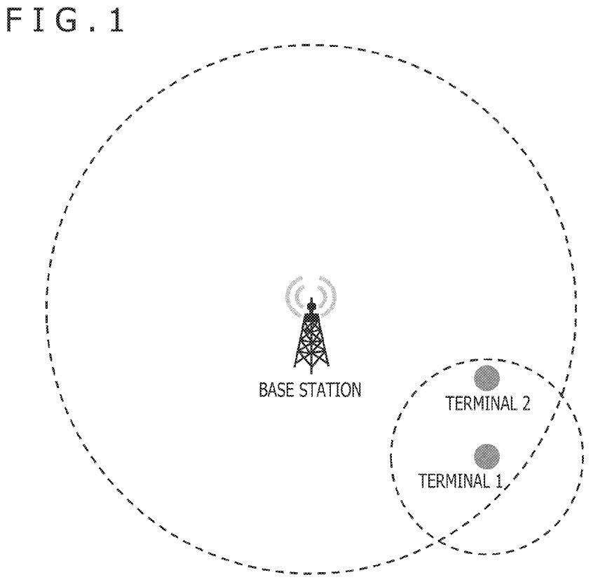

FIG. 1 depicts an example of a wireless communication system assumed in the first embodiment. The wireless communication system depicted in the figure includes one base station, and a terminal 1 and a terminal 2 present within a receivable range for receiving signals from the base station. In this figure, each of the receivable ranges for receiving signals from the base station and the terminal 1 is surrounded and indicated by a dotted line. Each of the base station and the respective terminals has a GPS function, and receives a GPS signal to acquire time information and synchronize internal clocks of the respective devices.

Moreover, each of the terminals determines a time, a frequency, and a code used for data frame transmission on the basis of a time and a terminal ID of the terminal in conformity with a rule determined beforehand. For example, each of the terminals receives an input of a time (by the minute) at which data frame transmission is requested and a terminal ID, and determines a wireless resource used for data frame transmission. In this manner, each of the terminals is allowed to perform data transmission using a wireless resource different for each terminal by inputting random values, i.e., a time and a terminal ID, retained in common by the base station and the terminal to the rule determined beforehand.

Moreover, each of the terminals is configured to regularly transmit a control frame to check the existence of the terminal in a case of new registration of a terminal ID (activation) or in a case where a terminal ID has been already registered in the base station. As a result, common random values included in the base station and the terminal are regularly variable. Accordingly, a wireless resource used for a data frame is also variable. In this case, improvement of interference resistance and security is offerable as an advantage. Moreover, the base station is also capable of recognizing a wireless resource used by each of the terminals for data frame transmission beforehand. Accordingly, efficient utilization of a calculation resource is achievable.

Indoor use or use in the ground is assumed as a use case for IoT (Internet of Things). Examples of this case include an indoor parking lot in vehicle tracking, and monitoring of a soil environment in agriculture. In this case, a GPS signal is difficult to receive on the terminal side. Accordingly, there arises a problem that time information is difficult to use as a common random value between the base station and the terminal.

According to the present embodiment, therefore, a wireless resource is determined based on a time and a terminal ID by achieving time synchronization using a control frame of a near terminal able to receive a GPS signal even in a case where a terminal unable to receive a GPS signal is present within a wireless communication system.

It is assumed that the wireless communication system depicted in FIG. 1 is a wireless sensor network which contains terminals each including a sensor terminal, and a base station collecting sensor data from the respective terminals. Each of the terminals transmits a data frame storing data acquired from a sensor, and also transmits a control frame regularly. Each of the terminals has a GPS function for time synchronization within the wireless communication system. However, there exist a terminal able to receive a GPS signal and a terminal unable to receive a GPS signal depending on a place where these terminals are installed. According to the example depicted in FIG. 1, it is assumed that the terminal 1 is a terminal unable to receive a GPS signal, and that the terminal 2 is a terminal able to receive a GPS signal. On the other hand, the base station receives a control frame and a data frame transmitted from each of the terminals to perform a demodulation process.

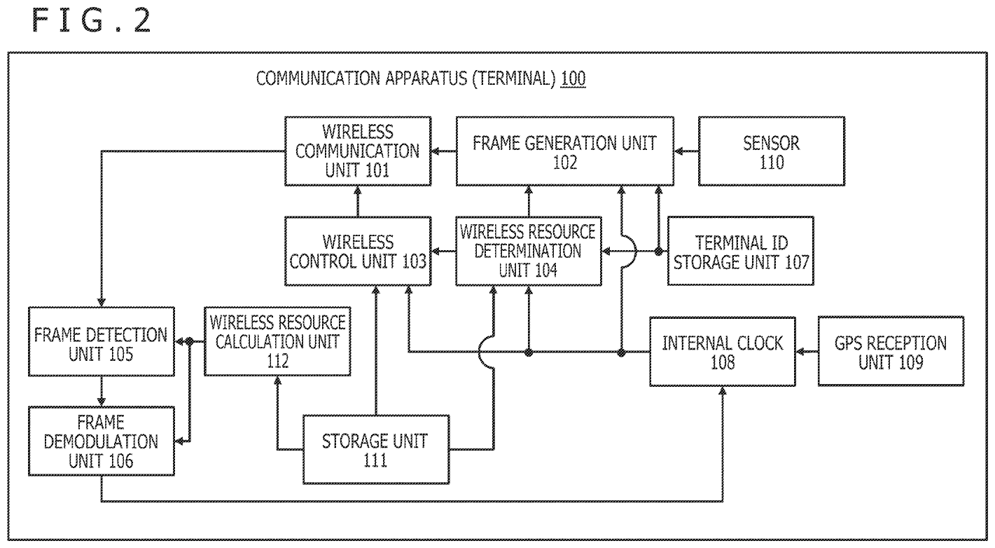

FIG. 2 depicts a configuration example of a communication apparatus 100 operating as a terminal in the wireless communication system according to the first embodiment. For example, the communication apparatus 100 is assumed to operate as a sensor terminal in the wireless sensor network. The communication apparatus 100 depicted in the figure includes a wireless communication unit 101, a frame generation unit 102, a wireless control unit 103, a wireless resource determination unit 104, a frame detection unit 105, a frame demodulation unit 106, a terminal ID storage unit 107, an internal clock 108, a GPS reception unit 109, a sensor 110, a storage unit 111, and a wireless resource calculation unit 112.

The wireless communication unit 101 transmits and receives a wireless signal. The wireless communication unit 101 converts a frame generated by the frame generation unit 102 into a wireless signal and transmits the wireless signal under the control by the wireless control unit 103. Moreover, the wireless communication unit 101 receives a radio wave, converts the radio wave into a wireless signal, and passes the wireless signal to the frame detection unit 105 under control by the wireless control unit 103.

The frame generation unit 102 generates a control frame and a data frame using a code determined by the wireless resource determination unit 104. The frame generation unit 102 generates a control frame storing time information. Moreover, in a case where the communication apparatus 100 operates as a sensor terminal in the wireless sensor network, the frame generation unit 102 generates a data frame containing information (sensor data) associated with the outside or the inside of the sensor terminal and acquired by the sensor 110 described below.

The wireless control unit 103 acquires a current time from the internal clock 108 and controls the wireless communication unit 101 in such a manner as to transmit a control frame and a data frame at a transmission time and a transmission frequency obtained from the wireless resource determination unit 104. Moreover, the wireless control unit 103 controls the wireless communication unit 101 such that the wireless communication unit 101 acquires, from the storage unit 111, a time and a frequency at which a control frame is received from another terminal, and performs a reception process at the corresponding time and frequency.

The wireless resource determination unit 104 determines a time, a frequency, and codes (SYNC code and scramble code) at which a control frame and a data frame are transmitted. The wireless resource determination unit 104 calculates a time, a frequency, and codes at which a frame is transmitted on the basis of information such as a current time clocked by the internal clock 108, a terminal ID stored in the terminal ID storage unit 107, and an initial value stored in the storage unit 111. Moreover, the wireless resource determination unit 104 determines a time, a frequency, and codes by using methods different for each of a control frame and a data frame. Details of the method for determining a wireless resource used for transmission of a control frame and a data frame will be described later.

The frame detection unit 105 detects a control frame from a reception signal received by the wireless communication unit 101. Specifically, the frame detection unit 105 extracts a signal at a targeted frequency from a broadband signal, generates a known sequence from a SYNC code and a scramble code acquired from the wireless resource calculation unit 112, calculates a correlation value between the known sequence and a reception signal, and determines that a frame has been detected in a case where the correlation value becomes a fixed value or larger. The frame detection unit 105 passes the detected time to the frame demodulation unit 106 in a case where detection of a control frame has succeeded.

The frame demodulation unit 106 demodulates a reception signal into a control frame. Specifically, the frame demodulation unit 106 cancels scrambling using a scramble code acquired from the wireless resource calculation unit 112, on the basis of a time detected by the frame detection unit 105. Thereafter, the frame demodulation unit 106 extracts a payload portion of the received frame and performs a demodulation process for demodulating an error correction code, and an error detection process using CRC (Cyclic Redundancy Code). Subsequently, in a case of a demodulation success of a control frame, the frame demodulation unit 106 passes time information contained in the control frame to the internal clock 108.

The terminal ID storage unit 107 stores an identifier unique to the corresponding terminal (communication apparatus 100).

The internal clock 108 acquires time information from the GPS reception unit 109 or the frame demodulation unit 106, and measures an elapsed time from a time of acquisition to calculate a current time.

The GPS reception unit 109 receives a GPS signal, acquires time information, and passes the time information to the internal clock 108.

The sensor 110 includes a sensor element equipped in the communication apparatus 100 functioning as a sensor terminal to acquire information associated with the outside or the inside of the sensor terminal and given as a notification using a data frame. For example, the sensor 110 includes a temperature sensor and an acceleration sensor. Moreover, in such a use case where acquisition of position information associated with the sensor terminal is desired, the GPS reception unit 109 may also function as the sensor 110.

The storage unit 111 retains wireless resource information necessary for detection and demodulation of a control frame. For example, in a case where a pseudorandom number generator is used to calculate a wireless resource (described below), the storage unit 111 retains initial values loaded to the pseudorandom number generator.

The wireless resource calculation unit 112 calculates a SYNC code and a scramble code necessary for detection of a control frame by the frame detection unit 105 and demodulation of a control frame by the frame demodulation unit 106. In a case where pseudorandom number generators are used to calculate these codes, the wireless resource calculation unit 112 loads initial values retained in the storage unit 111 to the pseudorandom number generators and calculates these codes (described below).

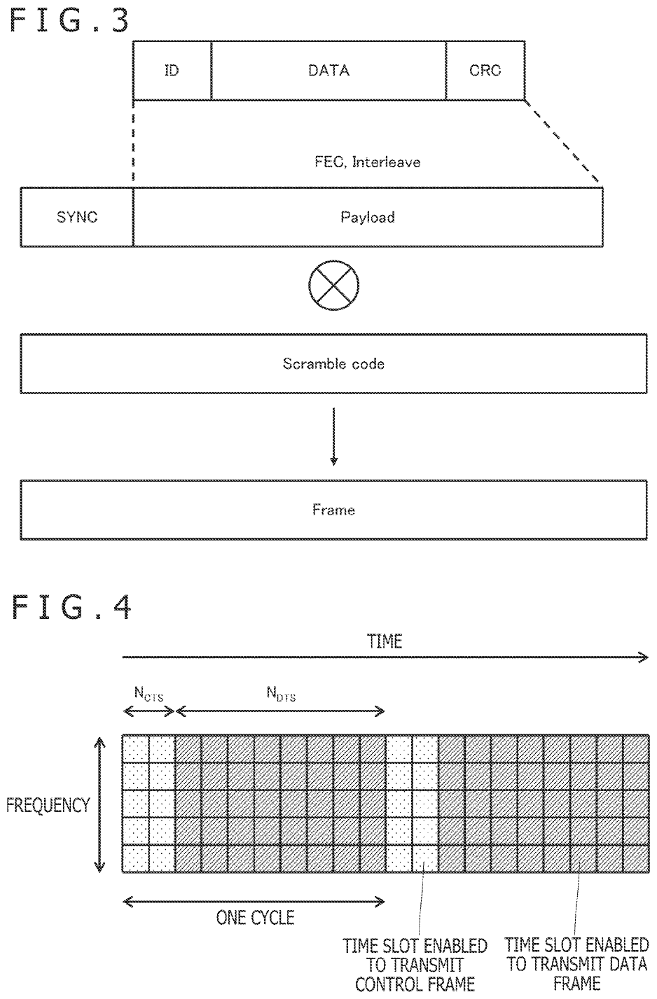

FIG. 3 depicts a configuration example of a frame used by the terminal at the time of transmission of a control frame and a data frame in the wireless communication system depicted in FIG. 1.

The frame contains an ID field, a DATA field, and a CRC field.

The ID field stores a terminal ID for identifying a terminal which is a transmission source of the corresponding frame.

In a case where the corresponding frame is a control frame, the DATA field stores a time at which the corresponding frame is transmitted. Moreover, in a case where the corresponding frame is a data frame, the DATA field stores information (sensor data) associated with the outside or the inside of the sensor terminal and acquired from the sensor unit 110.

The CRC field stores a CRC value calculated for each of values stored in the respective ID field and DATA field described above. The reception side of the corresponding frame is capable of determining whether or not frame reception has succeeded on the basis of the CRC values stored in the CRC field.

An error correction (FEC: Forward Error Correction) and an order interleaving process (Interleave) are performed for a sequence connecting ID, DATA, and CRC described above.

After connecting a sequence (Payload) subjected to the above process and a SYNC code used for frame detection, exclusive OR (XOR) is further obtained for each bit using a scramble code to generate a frame.

The SYNC code and the scramble code used here are codes determined by the wireless resource determination unit 104. In a case of a control frame, a SYNC code and a scramble code common to all terminals are used. On the other hand, used in a case of a data frame is a value obtained by inputting a time at which a control frame is transmitted, and a terminal ID stored in the terminal ID storage unit 107 to a rule determined beforehand. Details of a method for determining the SYNC code and the scramble code will be described later.

Subsequently described will be a wireless resource determination method used for transmission of a control frame and a data frame in the present embodiment.

FIG. 4 depicts an outline of a wireless resource of the wireless communication system according to the present embodiment. In this figure, a horizontal axis represents a time axis, while a vertical axis represents a frequency axis.

A time is divided into fixed sections called time slots. Moreover, a frequency is divided into channels each used for transmission and reception. It is assumed that a control frame and a data frame are transmitted within each time slot section. Furthermore, for avoiding a collision between a control frame and a data frame, time slots are set beforehand such that a time slot allowing transmission of a control frame is different from a time slot allowing transmission of a data frame. According to the example depicted in FIG. 4, the number of time slots for a control frame is N_{CTS}, while the number of time slots for a data frame is N_{DTS}. In addition, the number corresponding to N_{CTS}+N_{DETS} of time slots is designated as one cycle to repeat the time slots for a control frame and a data frame.

A wireless resource determination method used for control frame transmission will be initially described.

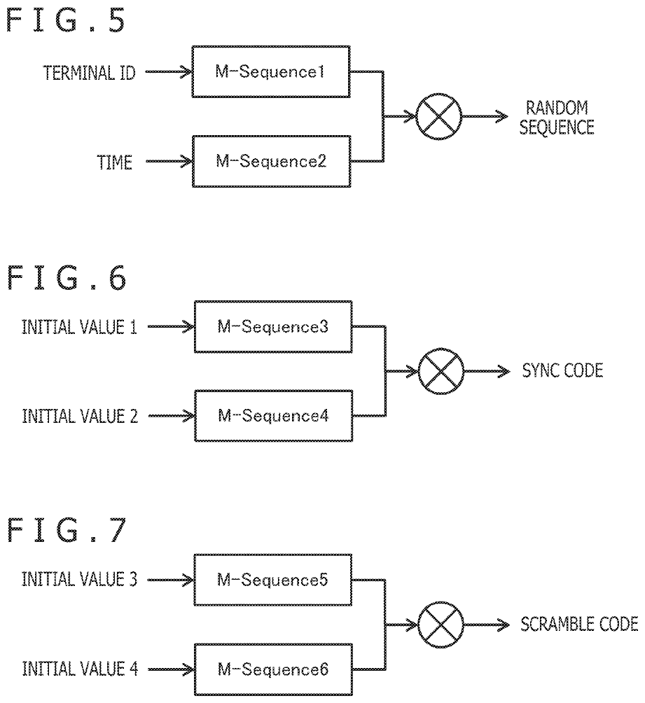

FIG. 5 depicts a pseudorandom number generator used for determination of a control frame transmission time. The pseudorandom number generator depicted in this figure is a gold code generator which uses two M sequences (Maximum length sequences). Initial values set for the respective M sequences including an M-Sequence 1 and an M-Sequence 2 are a terminal ID, and a time at which a control frame transmission request is issued within the corresponding terminal, respectively. Thereafter, a transmission time of a control frame T_{Ctx} is determined using a random sequence x generated by the pseudorandom generator according to with following Equation (1).

$$[ Math . 1 ]$$

$${T}_{Ctx} = {L}_{TS} \times mod ( \frac{x}{{N}_{CTS}} ) + {L}_{period} \times ceil ( \frac{t}{{L}_{period}} ) \qquad ( 1 )$$

Note that the followings are assumed in Equation (1) described above. Specifically, T_{Ctx} is a control frame transmission start time, L_{TS} is a length of a time slot, N_{CTS} is the number of control frame time slots (in one cycle), N_{DTS} is the number of data frame time slots (in one cycle), L_{period} is a length of one cycle (i.e., L_{period}=Lₜₛ×(N_{CTS}+N_{DTS})), t is a time at which a control frame transmission request is issued, and x is a random number sequence generated by the pseudorandom number generator (see FIG. 5).

Moreover, a control frame transmission frequency is determined using the pseudorandom number generator depicted in FIG. 5 similarly to the control frame transmission time. A combination of M sequence forming polynomials of the pseudorandom number generator used for determining the transmission frequency may be either the same as or different from the combination used for determining the transmission time described above. Initial values set for the respective M sequences are a terminal ID and a time at which a control frame transmission request is issued within the corresponding terminal. Thereafter, a transmission frequency (transmission channel) is determined using a random sequence x generated by the pseudorandom generator according to with following Equation (2).

$$[ Math . 2 ]$$

$${F}_{Ctx} = mod ( \frac{x}{{N}_{Cfreq}} ) + {F}_{Coffset} \qquad ( 2 )$$

Note that the followings are assumed in Equation (2) described above. Specifically, F_{Cts} is a control frame transmission channel, N_{Cfreq} is the number of channels available for a control frame, and F_{Coffset} is a channel offset of a control frame transmission frequency.

Moreover, it is assumed that a SYNC code and a scramble code used for a control frame are common codes within the wireless communication system. FIGS. 6 and 7 depict pseudorandom number generators used for generation of the SYNC code and the scramble code, respectively. The pseudorandom number generator depicted in FIG. 6 is a gold code generator using two M sequences (M-Sequence 3 and M-Sequence 4), while the pseudorandom number generator depicted in FIG. 7 is a gold code generator using two M sequences (M-Sequence 5 and M-Sequence 6). It is assumed that a length of the SYNC code coinciding with a SYNC length of a frame is obtained using the pseudorandom number generator depicted in FIG. 6, and that a length of the scramble code coinciding with a frame length is obtained using the pseudorandom number generator depicted in FIG. 7. Initial values 1 to 4 set in a control frame are values common within the wireless communication system, and are determined beforehand and retained in the storage unit 111.

A wireless resource determination method used for data frame transmission will next be described.

A data frame transmission time is determined using the pseudorandom number generator depicted in FIG. 5 similarly to a control frame. Initial values set for the respective M sequences including the M-Sequence 1 and the M-Sequence 2 are a terminal ID and a time at which a control frame is transmitted from the corresponding terminal, respectively. Thereafter, a data frame transmission time T_{Dxt} is determined using a random sequence x generated by the pseudorandom generator according to with following Equation (3).

$$[ Math . 3 ]$$

$${T}_{Dtx} = {L}_{TS} \times mod ( \frac{x}{{N}_{DTS}} ) + {L}_{period} \times ( ceil ( \frac{t}{{L}_{period}} ) \times {N}_{offset} ) + {L}_{TS} \times {N}_{CTS} \qquad ( 3 )$$

Note that the followings are assumed in Equation (3) described above. Specifically, T_{Dxt} is a data frame transmission start time, the terminal ID, L_{TS} is a length of a time slot, N_{CTS} is the number of control frame time slots (in one cycle), N_{DTS} is the number of data frame time slots (in one cycle), L_{period} is a length of one cycle (i.e., L_{period}=Lₜₛ×(N_{CTS}+N_{DTS})) N_{offset} is an offset value from transmission of a control frame to transmission of a data frame, t is a time at which a control frame transmission request is issued, and x is a random number sequence generated by the pseudorandom number generator (see FIG. 5).

Moreover, a data frame transmission frequency is determined using the pseudorandom number generator similarly to the data frame transmission time. Initial values set for the respective M sequences are a terminal ID and a time at which a control frame transmission request is issued within the terminal. Thereafter, a transmission frequency (transmission channel) is determined using a random sequence x generated by the pseudorandom generator according to with following Equation (4).

$$[ Math . 4 ]$$

$${F}_{Dtx} = mod ( \frac{x}{{N}_{Dfreq}} ) + {F}_{Doffset} \qquad ( 4 )$$

Note that the followings are assumed in Equation (4) described above. Specifically, F_{Dts} is a data frame transmission channel, N_{Dfreq} is the number of channels available for a data frame, and F_{Doffset} is a channel offset of a data frame transmission frequency.

Moreover, a SYNC code and a scramble code used for a data frame are determined using the pseudorandom number generators depicted in FIGS. 6 and 7, respectively, similarly to a control frame. It is assumed that a length of the SYNC code coinciding with a SYNC length of a frame is obtained using the pseudorandom number generator depicted in FIG. 6, and that a length of the scramble code coinciding with a frame length is obtained using the pseudorandom number generator depicted in FIG. 7. Each of initial values 1 and 3 set in a data frame is a terminal ID, while each of initial values 2 and 4 is a time at which a control frame is transmitted.

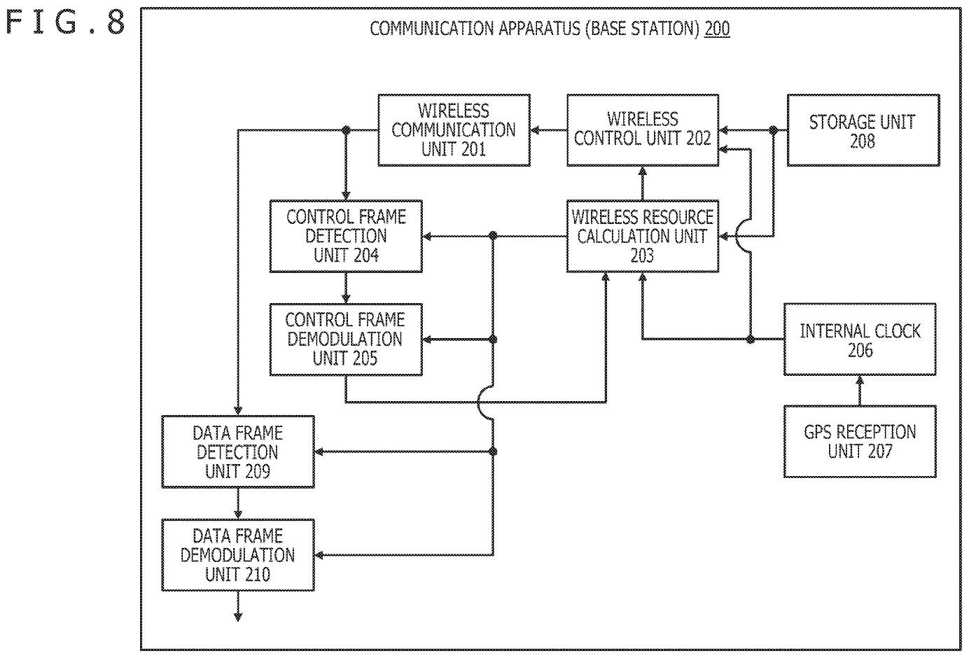

FIG. 8 depicts a configuration example of a communication apparatus 200 operating as a base station in the wireless communication system according to the first embodiment. For example, it is assumed that the communication apparatus 200 performs an operation for receiving a data frame containing sensor data from each of sensor terminals in the wireless sensor network. The communication apparatus 200 depicted in the figure includes a wireless communication unit 201, a wireless control unit 202, a wireless resource calculation unit 203, a control frame detection unit 204, a control frame demodulation unit 205, an internal clock 206, a GPS reception unit 207, a storage unit 208, a data frame detection unit 209, and a data frame demodulation unit 210.

The wireless communication unit 201 receives a wireless signal. The wireless communication unit 201 receives a radio wave and converts the radio wave into a wireless signal under control by the wireless control unit 202. Thereafter, in a case where an instruction from the wireless control unit 202 is reception of a control frame, the wireless communication unit 201 passes a reception signal to the control frame detection unit 204. In a case where an instruction from the wireless control unit 202 is reception of a data frame, the wireless communication unit 201 passes a reception signal to the data frame detection unit 209. Note that the wireless communication unit 201 may transmit a wireless signal. However, description of details of this point is omitted.

The wireless control unit 202 acquires a current time from the internal clock 206 and controls the wireless communication unit 201 in such a manner as to receive a control frame and a data frame at a reception time and a reception frequency obtained by the wireless resource calculation unit 203. The terminal ID of the terminal which transmits a control frame is unknown. Accordingly, the wireless control unit 202 controls the wireless communication unit 201 in such a manner as to perform a reception process for time slots and all frequencies available for control frame transmission. On the other hand, the terminal ID of the terminal which transmits a data frame is known on the basis of a control frame. Accordingly, the wireless control unit 202 controls the wireless communication unit 201 in such a manner as to perform a reception process for only a time and a frequency calculated by the wireless resource calculation unit 203 in conformity with a rule determined beforehand. Moreover, in a case where the communication apparatus 200 functioning as a base station also transmits frames, the wireless control unit 202 also controls a transmission operation performed by the wireless communication unit 201 for transmitting wireless signals. However, description of details of this point is omitted.

The wireless resource calculation unit 203 calculates times, frequencies, and codes (SYNC code and scramble code) at which a control frame and a data frame of a terminal whose terminal ID has been registered beforehand are transmitted. The wireless resource calculation unit 203 calculates the times, the frequencies, and the codes by using methods different for each of the control frame and the data frame (described above).

The control frame detection unit 204 detects a control frame from a reception signal received by the wireless communication unit 201. Specifically, the control frame detection unit 204 extracts a signal at a targeted frequency from a broadband signal, generates a known sequence from a SYNC code and a scramble code calculated by the wireless resource calculation unit 203, calculates a correlation value between the known sequence and a reception signal, and determines that a control frame has been detected in a case where the correlation value becomes a fixed value or larger. The control frame detection unit 204 passes the detected time to the control frame demodulation unit 205 in a case where detection of a control frame has succeeded.

The control frame demodulation unit 205 demodulates a reception signal into a control frame. Specifically, the control frame demodulation unit 205 cancels scrambling using a scramble code acquired from the wireless resource calculation unit 203, on the basis of a time detected by the control frame detection unit 204. Thereafter, the control frame demodulation unit 205 extracts a payload portion of the received frame, and performs a demodulation process for demodulating an error correction code, and an error detection process using CRC. Subsequently, in a case of a demodulation success of the control frame, the control frame demodulation unit 205 passes the terminal ID contained in the control frame to the wireless resource calculation unit 203.

The GPS reception unit 207 receives a GPS signal, and acquires time information. The internal clock 206 acquires time information from the GPS reception unit 207 and measures an elapsed time from a time of acquisition to calculate a current time.

The storage unit 208 retains wireless resource information necessary for detection and demodulation of a control frame. For example, in a case of calculation of a wireless resource using pseudorandom number generators (see FIGS. 6 and 7), the storage unit 208 retains initial values loaded to the pseudorandom number generators.

The data frame detection unit 209 detects a data frame from a reception signal received by the wireless communication unit 201. Specifically, the data frame detection unit 209 extracts a signal at a targeted frequency from a broadband signal, generates a known sequence from a SYNC code and a scramble code calculated by the wireless resource calculation unit 2031, calculates a correlation value between the known sequence and a reception signal, and determines that a data frame has been detected in a case where the correlation value becomes a fixed value or larger. The data frame detection unit 209 passes the detected time to the data frame demodulation unit 210 in a case where detection of a data frame has succeeded.

The data frame demodulation unit 210 demodulates a reception signal into a control frame. Specifically, the data frame demodulation unit 210 cancels scrambling using a scramble code acquired from the wireless resource calculation unit 203, on the basis of a time detected by the data frame detection unit 209. Thereafter, the data frame demodulation unit 210 extracts a payload portion of the received frame and performs a demodulation process for demodulating an error correction code, and an error detection process using CRC. Subsequently, in a case where demodulation of a data frame has succeeded, the data frame demodulation unit 210 notifies an upper layer application or the like of reception data such as sensor data contained in the data frame.

According to the wireless communication system of the present embodiment, each of the terminals transmits a data frame containing sensor data, while the base station collects sensor data from each of the terminals. Each of the terminals is configured to transmit a control frame beforehand and give a notification of information associated with a wireless resource used for transmission of a data frame. Each of the terminals basically determines a wireless resource used for transmission of a data frame on the basis of time information acquired from a received GPS signal.

A terminal unable to receive a GPS signal here is capable of acquiring time information described in a control frame received from a near terminal to determine a wireless resource used by the terminal for data frame transmission. Moreover, the base station is capable of acquiring, from a control frame received from a terminal under control by the base station, information associated with a wireless resource used by the terminal for data frame transmission by the terminal to calculate a wireless resource targeted for a reception process for receiving a data frame from the control frame received by the terminal.

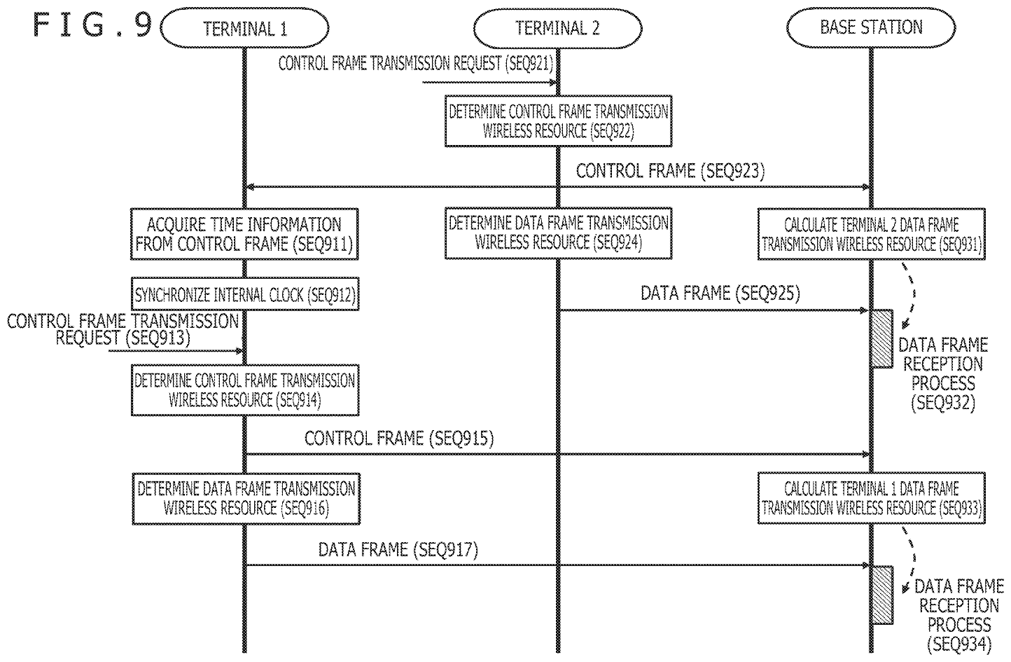

FIG. 9 depicts a communication sequence example of the wireless communication system depicted in FIG. 1. In this case, it is assumed that each of the terminals 1 and 2 has the device configuration depicted in FIG. 2, and that the base station has the device configuration depicted in FIG. 8. Moreover, it is assumed here that the terminal 2 is able to receive a GPS signal, but that the terminal 1 is unable to receive a GPS signal.

The terminal 2 able to receive a GPS signal determines a wireless resource (time, frequency, and codes) used for control frame transmission in accordance with the method described above (SEQ922) in response to reception of a control frame transmission request from an upper layer (SEQ921).

Thereafter, the terminal 2 generates a control frame using calculated SYNC code and scramble code, and transmits the control frame at the determined time and frequency (SEQ923).

The terminal 2 transmits the control frame by broadcasting. Accordingly, the control frame of the terminal 2 is received by both the base station and the terminal 1.

The base station having received the control frame from the terminal 2 demodulates the control frame, and calculates a wireless resource (time, frequency, and codes) used by the terminal 2 for data frame transmission using a terminal ID stored in the control frame, and a time at which the control frame is received (SEQ931). The terminal ID and the time at which the control frame is received correspond to information associated with the wireless resource and acquired by the base station from the control frame.

Thereafter, the terminal 2 determines a wireless resource (time, frequency, and codes) used for data frame transmission (SEQ924), and transmits a data frame at the determined time and frequency (SEQ925).

When the time calculated based on the information acquired from the control frame received from the terminal 2 comes, the base station receives a wireless signal at the calculated frequency, and detects and demodulates the data frame received from the terminal 2 using the calculated codes (SEQ932).

On the other hand, the terminal 1 unable to receive a GPS signal receives and demodulates the control frame of the terminal 2, acquires time information stored in the control frame (SEQ911), and synchronizes the internal clock 108 within the terminal 1 on the basis of the acquired time information (SEQ912). The time information corresponds to information associated with the wireless resource and acquired by the terminal 1 from the control frame of the terminal 2 located nearby.

Thereafter, similarly to the terminal 2 able to receive a GPS signal, the terminal 1 determines a wireless resource (time, frequency, and codes) used for control frame transmission in accordance with the method described above (SEQ914), and transmits a control frame at the determined time and frequency by broadcasting (SEQ915) in response to reception of a control frame transmission request from an upper layer (SEQ913).

The base station having received the control frame from the terminal 1 demodulates the control frame, and calculates a wireless resource (time, frequency, and codes) used by the terminal 1 for data frame transmission using a terminal ID stored in the control frame, and a time at which the control frame is received (SEQ933). The terminal ID and the time at which the control frame is received correspond to information associated with the wireless resource and acquired by the base station from the control frame (the same as above).

Thereafter, the terminal 1 further determines a wireless resource (time, frequency, and codes) used for data frame transmission (SEQ916), and transmits a data frame at the determined time and frequency (SEQ917).

When the time calculated based on the control frame received from the terminal 1 comes, the base station receives a wireless signal at the calculated frequency, and detects and demodulates the data frame received from the terminal 1 using the calculated codes (SEQ934).

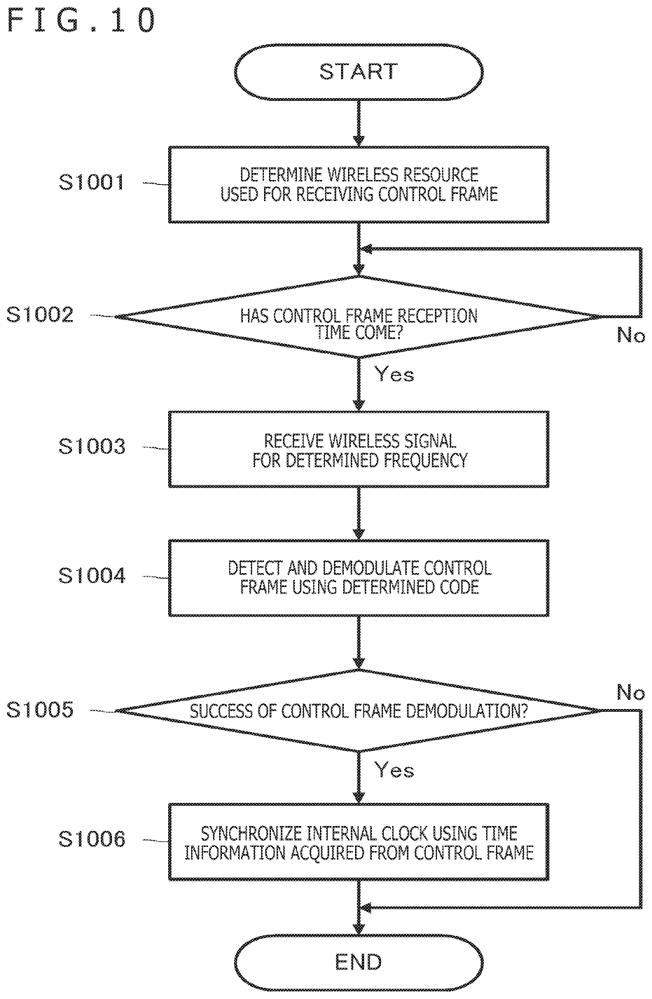

FIG. 10 presents a processing procedure in the form of a flowchart performed by a terminal for acquiring time information from a control frame of another terminal. In this case, it is assumed that the terminal has the device configuration depicted in FIG. 2.

Initially, the terminal determines a wireless resource (time, frequency, and codes) used for control frame reception from a near terminal (step S1001). It is difficult to recognize beforehand a time and a frequency of control frame transmission by another terminal located within a reception range of the terminal. Accordingly, the terminal basically performs a reception process for all times (all time slots) and frequencies available for control frame transmission.

Subsequently, the terminal determines whether or not the control frame reception time determined in step S1001 has come (step S1002).

Thereafter, when the control frame reception time comes (Yes in step S1002), the terminal performs a reception process for receiving a wireless signal at the frequency determined in step S1001 (step S1003).

Subsequently, the terminal performs a process for detecting and demodulating the control frame using the codes determined in step S1001 (step S1004). Then, the terminal determines whether or not demodulation of the control frame has succeeded (step S1005).

In a case where demodulation of the control frame has succeeded (Yes in step S1005), the terminal synchronizes the internal clock 108 of the terminal using time information acquired from the control frame (step S1006), and ends the present process.

Moreover, in a case where demodulation of the control frame has failed (No in step S1005), the terminal ends the present process without synchronizing the internal clock 108 of the terminal.

The process presented in FIG. 10 is basically performed by a terminal unable to receive a GPS signal. A terminal able to receive a GPS signal is capable of acquiring time information from a GPS signal, and therefore need not perform the process presented in FIG. 10.

In addition, the terminal is not required to constantly perform the process presented in FIG. 10. For example, in a case where the terminal has succeeded the process presented in FIG. 10 once and completed synchronization of the internal clock, the terminal need not perform this process for a certain period of time.

For example, in the communication sequence example presented in FIG. 9, the terminal 1 performing the processing procedure presented in FIG. 10 is capable of acquiring time information from a control frame received from the terminal 2 as information associated with a wireless resource, and determining a wireless resource used for data frame transmission by the terminal 1 on the basis of the time information.

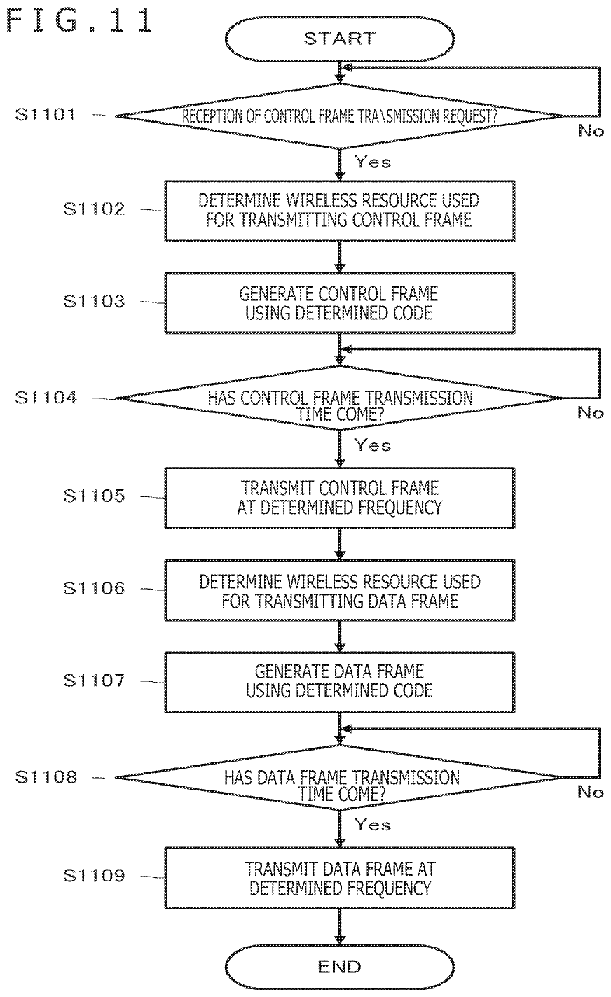

FIG. 11 presents a processing procedure in the form of a flowchart performed by a terminal for transmitting a control frame and a data frame. It is assumed here that the terminal transmits one data frame for each control frame. It is further assumed that the terminal has the device configuration depicted in FIG. 2.

Initially, the terminal determines whether or not the terminal has received a control frame transmission request from an upper layer (step S1101).

In a case where a control frame transmission request has been received (Yes in step S1101), the terminal determines a wireless resource (time, frequency, and codes) used for control frame transmission in accordance with the method described above (step S1102).

Subsequently, the terminal generates a control frame using the codes determined in step S1102 (step S1103). Thereafter, the terminal determines whether or not the control frame transmission time determined in step S1102 has come (step S1104).

When the control frame transmission time comes (Yes in step S1104), the terminal transmits the control frame at the frequency determined in step S1102 (step S1105).

Subsequently, the terminal determines a wireless resource (time, frequency, and codes) used for data frame transmission in accordance with the method described above (step S1106).

Thereafter, the terminal generates a data frame using the codes determined in step S1106 (step S1107). Furthermore, the terminal determines whether or not the data frame transmission time determined in step S1106 has come (step S1108).

When the data frame transmission time comes (Yes in step S1108), the terminal transmits the data frame at the frequency determined in step S1106 (step S1109), and ends the present process.

For example, in the communication sequence example presented in FIG. 9, each of the terminals 1 and 2 sequentially transmits a control frame and a data frame by performing the processing procedure presented in FIG. 11. The terminal 2 notifies, using a control frame, the base station or the terminal 1 located nearby of time information acquired from a received GPS signal as information associated with a wireless resource used by the terminal 2 for data frame transmission. In addition, the terminal 2 determines a wireless resource used by the terminal 2 for data frame transmission in accordance with the method described above on the basis of the time information acquired from the GPS signal. On the other hand, the terminal 1 unable to receive a GPS signal is capable of acquiring time information from a control frame of the terminal 2 in accordance with the processing procedure presented in FIG. 10, and then determining a wireless resource used by the terminal 1 for data frame transmission on the basis of time information. The terminal 1 therefore sequentially transmits a control frame and a data frame in accordance with the processing procedure presented in FIG. 11.

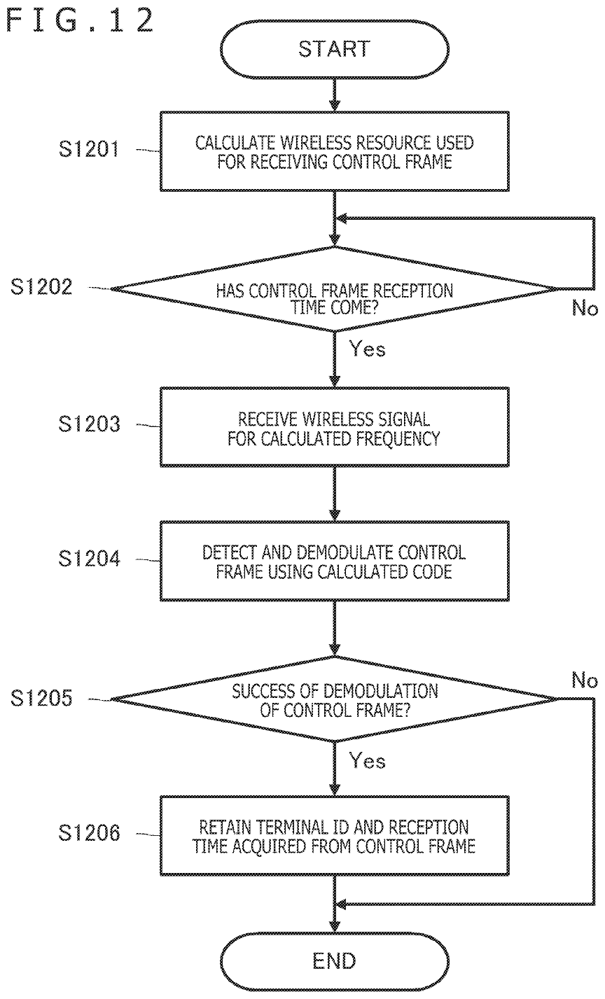

FIG. 12 presents a processing procedure in the form of a flowchart performed by a base station for receiving a control frame from a terminal. In this case, it is assumed that the base station has the device configuration depicted in FIG. 8.

Initially, the base station calculates a wireless resource (time, frequency, and codes) used for control frame reception (step S1201). It is difficult to recognize beforehand a time and a frequency of control frame transmission from a terminal located within a reception range of the base station. Accordingly, the base station basically performs a reception process for all times (all time slots) and frequencies available for control frame transmission.

Subsequently, the base station calculates whether or not the control frame reception time calculated in step S1201 has come (step S1202).

Thereafter, when the control frame reception time comes (Yes in step S1202), the base station performs a process for receiving a wireless signal at the frequency calculated in step S1201 (step S1203).

Subsequently, the base station performs a process for detecting and demodulating the control frame using the codes calculated in step S1201 (step S1204). Then, the base station determines whether or not demodulation of the control frame has succeeded (step S1205).

In a case where demodulation of the control frame has succeeded (Yes in step S1205), the base station is capable of acquiring, from the control frame, a terminal ID and a reception time at which the control frame is received as information associated with a wireless resource used by a terminal corresponding to a transmission resource of the control frame for data frame transmission. Thereafter, the base station retains the acquired terminal ID and reception time (step S1206), and ends the present process.

In addition, in a case where demodulation of the control frame has failed (No in step S1205), the base station ends the present process without acquiring the terminal ID and the reception time from the control frame.

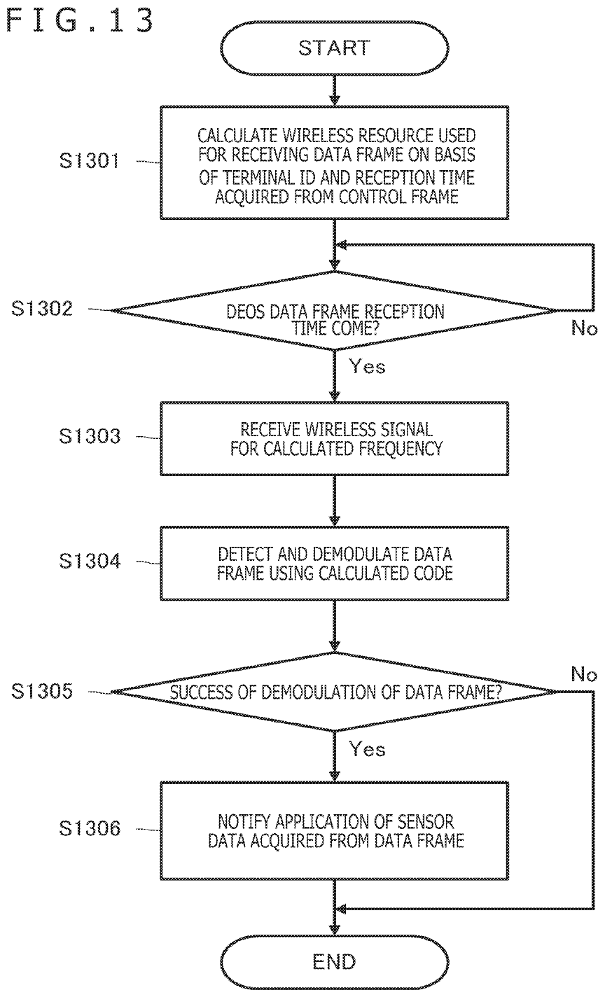

FIG. 13 presents a processing procedure in the form of a flowchart performed by a base station for receiving a data frame from a terminal. In this case, it is assumed that the base station has the device configuration depicted in FIG. 8.

Initially, the base station calculates a wireless resource (time, frequency, and codes) used for data frame reception on the basis of a terminal ID and a control frame reception time acquired from a control frame of the terminal (step S1301).

Subsequently, the base station determines whether or not the data frame reception time calculated in step S1301 has come (step S1302).

Thereafter, when the data frame reception time comes (Yes in step S1302), the base station performs a reception process for receiving a wireless signal at the frequency calculated in step S1301 (step S1303).

Subsequently, the base station performs a process for detecting and demodulating a data frame using the codes calculated in step S1301 (step S1304). Then, the base station determines whether or not demodulation of the data frame has succeeded (step S1305).

In a case where demodulation of the data frame has succeeded (Yes in step S1305), the base station notifies the upper layer application of sensor data acquired from the data frame (step S1306), and the present process ends.

In addition, in a case where demodulation of the data frame has failed (No in step S1305), the base station ends the present process without acquiring sensor data from the data frame.

For example, in the communication sequence example presented in FIG. 9, the base station is capable of acquiring a terminal ID and a control frame reception time from each of control frames received from the respective terminals under control by the base station (terminals 1 and 2) by performing the processing procedure presented in FIG. 12 as information associated with a wireless resource used by the corresponding terminal for data frame transmission. Thereafter, the base station is capable of receiving a data frame by performing the processing procedure presented in FIG. 13 in accordance with the method described above on the basis of the terminal ID and the control frame reception time acquired from each of the control frames of the respective terminals.

As described above, according to the present embodiment, even in a case where a terminal itself is unable to receive a GPS signal and acquire time information, the terminal achieves time synchronization by acquiring time information from a control frame transmitted from a terminal located nearby. In this manner, even an asymmetric communication system is capable of achieving time synchronization, and autonomously selecting a wireless resource allowing avoidance of a collision with a frame transmitted from another terminal and allowing separation.

### Embodiment 2

According to the first embodiment described above, one or more terminals each able to receive a GPS signal need to be present within the wireless communication system. However, there is a possibility that none of the terminals within the wireless communication system is able to receive a GPS signal.

Accordingly, proposed in a second embodiment is a method which achieves time synchronization even in an asymmetric communication system by issuing a notification of time information from a base station using a DL beacon frame, and sharing time information between near terminals using a control frame. In this case, it is similarly assumed in the second embodiment that a wireless resource (time, frequency, and codes) used for transmission is determined using a time as a common random value within the wireless communication system.

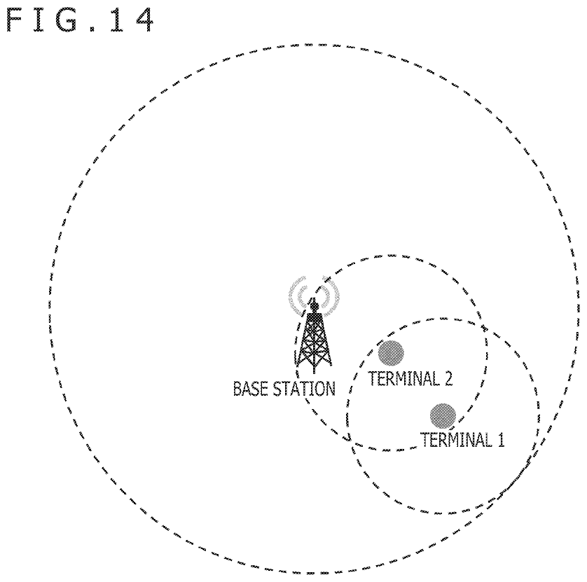

FIG. 14 depicts an example of a wireless communication system assumed in the second embodiment. The wireless communication system depicted in the figure includes one base station, and the terminal 1 and the terminal 2 present within a receivable range of signals from the base station. In the figure, each of the receivable ranges of signals from the base station and the terminals 1 and 2 is surrounded and indicated by a dotted line.

It is assumed that the wireless communication system depicted in FIG. 14 is a wireless sensor network which includes terminals each including a sensor terminal, and a base station collecting sensor data from the respective terminals. Each of the terminals transmits a data frame storing data acquired from a sensor, and also transmits a control frame regularly. On the other hand, the base station receives a control frame and a data frame transmitted from each of the terminals, and performs a demodulation process for the received frames.

Moreover, the base station regularly transmits a DL beacon storing time information to the terminals under control by the base station. However, there exist both a terminal able to receive a GPS signal and a terminal unable to receive a DL beacon depending on an installation place of the base station. According to the example depicted in FIG. 14, it is assumed that the terminal 1 is a terminal unable to receive a DL beacon, and that the terminal 2 is a terminal able to receive a DL beacon.

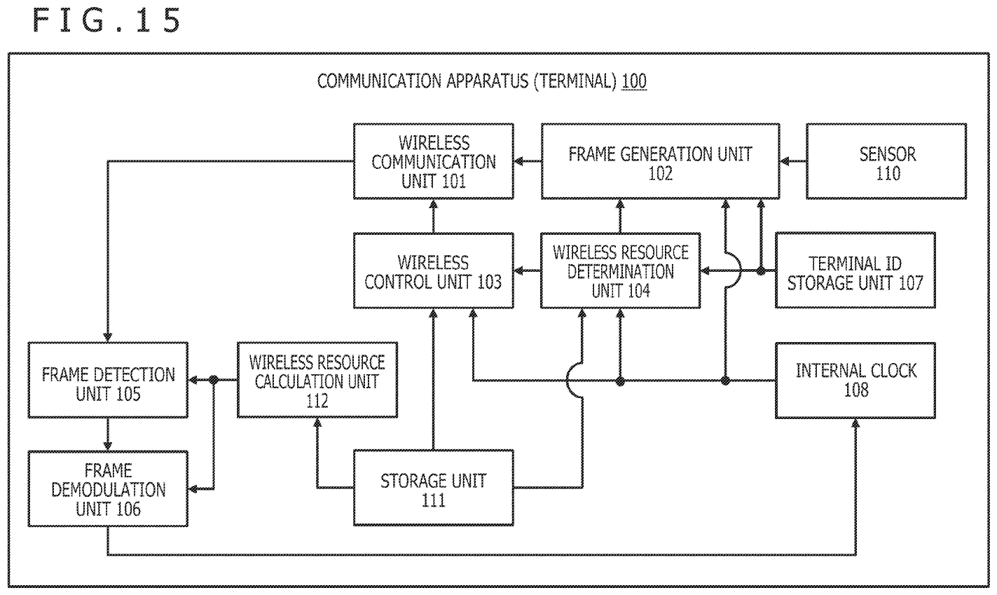

FIG. 15 depicts a configuration example of the communication apparatus 100 operating as a terminal in the wireless communication system according to the second embodiment. For example, the communication apparatus 100 is assumed to operate as a sensor terminal in the wireless sensor network. The communication apparatus 100 depicted in the figure includes the wireless communication unit 101, the frame generation unit 102, the wireless control unit 103, the wireless resource determination unit 104, the frame detection unit 105, the frame demodulation unit 106, the terminal ID storage unit 107, the internal clock 108, the sensor 110, the storage unit 111, and the wireless resource calculation unit 112.

The wireless communication unit 101 converts a frame generated by the frame generation unit 102 into a wireless signal, and transmits the wireless signal under control by the wireless control unit 103. Moreover, the wireless communication unit 101 receives a radio wave, converts the radio wave into a wireless signal, and passes the wireless signal to the frame detection unit 105 under control by the wireless control unit 103.

The frame generation unit 102 generates a control frame and a data frame using codes determined by the wireless resource determination unit 104. The frame generation unit 102 generates a control frame storing time information. Moreover, in a case where the communication apparatus 100 operates as a sensor terminal in the wireless sensor network, the frame generation unit 102 generates a data frame containing information (sensor data) associated with the outside or the inside of the sensor terminal and acquired by the sensor 110 described later.

The wireless control unit 103 acquires a current time from the internal clock 108, and controls the wireless communication unit 101 in such a manner as to transmit a control frame and a data frame at a transmission time and a transmission frequency obtained from the wireless resource determination unit 104. Moreover, the wireless control unit 103 controls the wireless communication unit 101 in such a manner as to acquire, from the storage unit 111, a time and a frequency at which a control frame is received from another terminal and perform a reception process at the corresponding time and frequency.

The wireless resource determination unit 104 determines a time, a frequency, and codes (SYNC code and scramble code) at which a control frame and a data frame are transmitted. The wireless resource determination unit 104 calculates the time, the frequency, and the codes at which a frame is transmitted on the basis of information such as a current time clocked by the internal clock 108 and a terminal ID stored in the terminal ID storage unit 107. Moreover, the wireless resource determination unit 104 determines the time, the frequency, and the codes by using methods different for each of a control frame and a data frame (described above).

The frame detection unit 105 detects a frame containing a control frame and a DL beacon frame from a reception signal received by the wireless communication unit 101. Specifically, the frame detection unit 105 extracts a signal at a frequency calculated by the wireless resource calculation unit 112 from a broadband signal, generates a known sequence using a SYNC code and a scramble code calculated by the wireless resource calculation unit 112, calculates a correlation value between the known sequence and a reception signal, and determines that a frame has been detected in a case where the correlation value becomes a fixed value or larger. The frame detection unit 105 passes the detected time to the frame demodulation unit 106 in a case where detection of a control frame or a DL beacon frame has succeeded.

The frame demodulation unit 106 cancels scrambling using a scramble code acquired from the wireless resource calculation unit 112, on the basis of a time detected by the frame detection unit 105. Thereafter, the frame demodulation unit 106 extracts a payload portion of the received frame and performs a demodulation process for demodulating an error correction code, and an error detection process using CRC. Thereafter, in a case where demodulation of the control frame or the DL beacon frame has succeeded, the frame demodulation unit 106 passes time information contained in the demodulated frame to the internal clock 108.

The terminal ID storage unit 107 stores an identifier unique to the corresponding terminal (communication apparatus 100).

The internal clock 108 acquires time information from the frame demodulation unit 106 and measures an elapsed time from a time of acquisition to calculate a current time. In addition, in a case where the communication apparatus 100 includes a GPS reception unit (not depicted), the internal clock 108 may measure an elapsed time from a time at which time information is acquired from a GPS signal, and calculate a current time.

The sensor 110 includes a sensor element equipped in the communication apparatus 100 functioning as a sensor terminal to acquire information associated with the outside or the inside of the sensor terminal and given as a notification using a data frame. For example, the sensor 110 includes a temperature sensor and an acceleration sensor.

The storage unit 111 retains wireless resource information necessary for detection and demodulation of a control frame. For example, in a case of calculation of a wireless resource using pseudorandom number generators (see FIGS. 6 and 7), the storage unit 111 retains initial values loaded to the pseudorandom number generators.

The wireless resource calculation unit 112 calculates a SYNC code and a scramble code necessary for detection of a control frame by the frame detection unit 105 and demodulation of a control frame by the frame demodulation unit 106. In a case of calculation of these codes using the pseudorandom number generators, the wireless resource calculation unit 112 loads initial values retained in the storage unit 111 to the pseudorandom number generators and calculates these codes (described above).

Note that the terminal acquires time information from a DL beacon frame in the present embodiment. Accordingly, a GPS reception unit for receiving a GPS signal is not necessarily required.

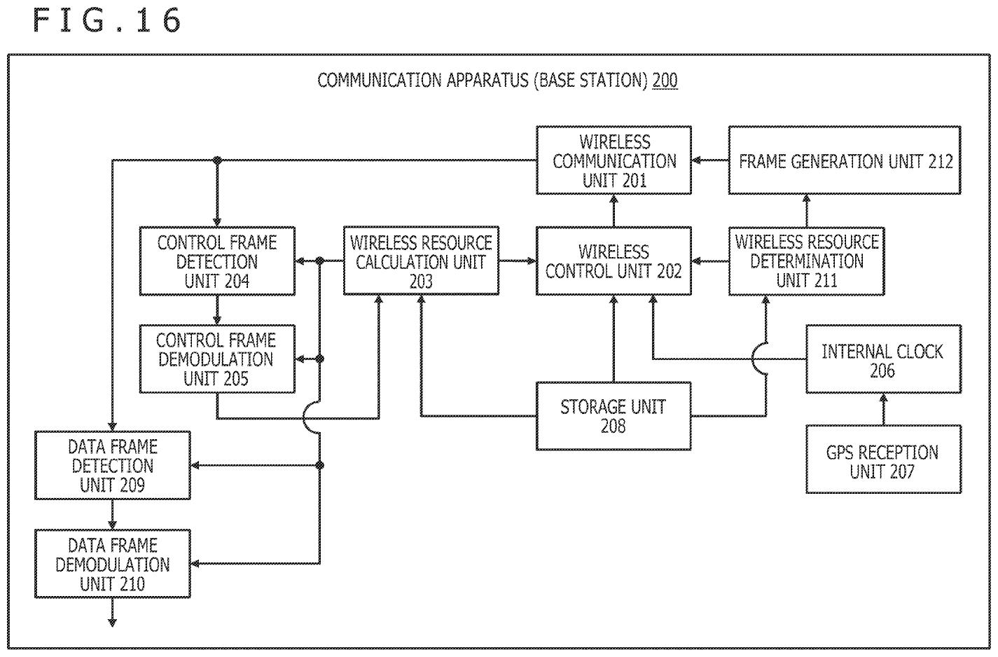

FIG. 16 depicts a configuration example of the communication apparatus 200 operating as a base station in the wireless communication system according to the second embodiment. For example, it is assumed that the communication apparatus 200 performs an operation for receiving data frames each containing sensor data from respective sensor terminals in a wireless sensor network. The communication apparatus 200 depicted in the figure includes the wireless communication unit 201, the wireless control unit 202, the wireless resource calculation unit 203, the control frame detection unit 204, the control frame demodulation unit 205, the internal clock 206, the GPS reception unit 207, the storage unit 208, the data frame detection unit 209, the data frame demodulation unit 210, a wireless resource determination unit 211, and a frame generation unit 212.

The wireless communication unit 201 transmits and receives a wireless signal. At the time of transmission of a DL beacon frame, the wireless communication unit 201 converts a DL beacon frame generated by the frame generation unit 212 into a wireless signal, and transmits the wireless signal under control by the wireless control unit 202. Moreover, at the time of reception of a frame, the wireless communication unit 201 receives a radio wave and converts the radio wave into a wireless signal under control by the wireless control unit 202. In a case where an instruction from the wireless control unit 202 is reception of a control frame, the wireless communication unit 201 passes a reception signal to the control frame detection unit 204. In a case where an instruction from the wireless control unit 202 is reception of a data frame, the wireless communication unit 201 passes a reception signal to the data frame detection unit 209.

The wireless resource determination unit 211 determines a time, a frequency, and codes (SYNC code and scramble code) at which a DL beacon frame is transmitted, on the basis of information stored in the storage unit 208.

The frame generation unit 212 generates a DL beacon frame which stores time information using the codes determined by the wireless resource determination unit 211.

The wireless control unit 202 acquires a current time from the internal clock 206 and controls the wireless communication unit 201 in such a manner as to transmit a DL beacon frame at a transmission time and a transmission frequency obtained by the wireless resource determination unit 211.

Moreover, the wireless control unit 202 acquires a current time from the internal clock 206 and controls the wireless communication unit 201 in such a manner as to receive a control frame and a data frame at a reception time and a reception frequency obtained by the wireless resource calculation unit 203. The terminal ID of the terminal which transmits a control frame is unknown. Accordingly, the wireless control unit 202 controls the wireless communication unit 201 in such a manner as to perform a reception process for time slots and all frequencies available for transmission of a control frame. On the other hand, the terminal ID of the terminal which transmits a data frame is known from a control frame. Accordingly, the wireless control unit 202 controls the wireless communication unit 201 in such a manner as to perform a reception process for only a time and a frequency calculated by the wireless resource calculation unit 203 in conformity with a rule determined beforehand.

The wireless resource calculation unit 203 calculates a time, a frequency, and codes (SYNC code and scramble code) at which a control frame and a data frame of a terminal whose terminal ID has been registered beforehand are transmitted. The wireless resource calculation unit 203 calculates a time, a frequency, and codes by using methods different for each of a control frame and a data frame (described above).

The control frame detection unit 204 extracts a signal at a targeted frequency from a broadband signal, generates a known sequence from a SYNC code and a scramble code calculated by the wireless resource calculation unit 203, calculates a correlation value between the known sequence and a reception signal, and determines that a control frame has been detected in a case where the correlation value becomes a fixed value or larger. The control frame detection unit 204 passes the detected time to the control frame demodulation unit 205 in a case where detection of a control frame has succeeded.

The control frame demodulation unit 205 cancels scrambling using a scramble code acquired from the wireless resource calculation unit 203, on the basis of a time detected by the control frame detection unit 204. Thereafter, the control frame demodulation unit 205 extracts a payload portion of the received frame, and performs a demodulation process for demodulating an error correction code, and an error detection process using CRC. Subsequently, in a case of a demodulation success of the control frame, the control frame demodulation unit 205 passes the terminal ID contained in the control frame to the wireless resource calculation unit 203.

The GPS reception unit 207 receives a GPS signal, and acquires time information. The internal clock 206 acquires time information from the GPS reception unit 207, and measures an elapsed time from a time of acquisition to calculate a current time.

The storage unit 208 retains wireless resource information necessary for detection and demodulation of a control frame. For example, in a case of calculation of a wireless resource using pseudorandom number generators (see FIGS. 6 and 7), the storage unit 208 retains initial values loaded to the pseudorandom number generators (the same as above).

The data frame detection unit 209 extracts a signal at a targeted frequency from a broadband signal, generates a known sequence from a SYNC code and a scramble code calculated by the wireless resource calculation unit 203, calculates a correlation value between the known sequence and a reception signal, and determines that a data frame has been detected in a case where the correlation value becomes a fixed value or larger. The data frame detection unit 209 passes the detected time to the data frame demodulation unit 210 in a case where detection of a data frame has succeeded.

The data frame demodulation unit 210 cancels scrambling using a scramble code acquired from the wireless resource calculation unit 203, on the basis of a time detected by the data frame detection unit 209. Thereafter, the data frame demodulation unit 210 extracts a payload portion of the received frame and performs a demodulation process for demodulating an error correction code, and an error detection process using CRC. Subsequently, in a case where demodulation of a data frame has succeeded, the data frame demodulation unit 210 notifies an upper layer application or the like of reception data such as sensor data contained in the data frame.

A DL beacon frame transmitted from the base station in the wireless communication system depicted in FIG. 14 has the same frame configuration as the frame configuration depicted in FIG. 3. However, in the DL beacon frame, the ID field stores an identifier of the base station, and the DATA field stores time information acquired from the internal clock 206 of the base station.

Subsequently described will be a wireless resource determination method used for transmission of a DL beacon frame in the present embodiment. Note that the wireless resource determination method used for transmission of a control frame and a data frame is similar to that method in the first embodiment. Accordingly, description of details of this method is omitted herein.

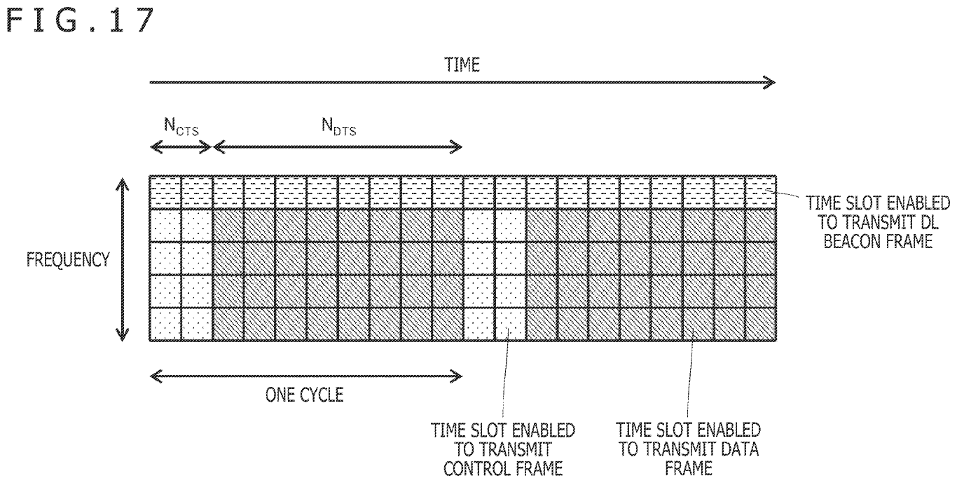

FIG. 17 depicts an outline of a wireless resource of the wireless communication system according to the present embodiment. In this figure, a horizontal axis represents a time axis, while a vertical axis represents a frequency axis.

A time is divided into fixed sections called time slots. Moreover, a frequency is divided into channels each used for transmission and reception. It is assumed that a control frame and a data frame are transmitted within each time slot section. Further, for avoiding a collision between a control frame and a data frame, time slots are set beforehand such that a time slot allowing transmission of a control frame is different from a time slot allowing transmission of a data frame. In addition, for avoiding a collision, a frequency different from frequencies of the control frame and the data frame is set for a DL beacon frame beforehand.

A wireless resource determination method used for transmission of a DL beacon frame will be more specifically described.

Concerning a beacon frame transmission time and a beacon frame transmission frequency, a DL beacon frame is transmitted at all transmittable frequencies for each time slot start time.

Moreover, it is assumed that a SYNC code and a scramble code used for a DL beacon frame are common codes within the wireless communication system. The SYNC code and the scramble code used for a DL beacon frame are generated by pseudorandom number generators (see FIGS. 6 and 7) each including a gold code generator using two M sequences similarly to a control frame and a data frame. Moreover, initial values 1 to 4 set in a DL beacon frame are values within the wireless communication system, and retained in the storage unit 208 and determined beforehand.

According to the wireless communication system of the present embodiment, each of the terminals transmits a data frame containing sensor data, while the base station collects sensor data from each of the terminals. Each of the terminals is configured to transmit a control frame beforehand and give a notification of information associated with a wireless resource used for data frame transmission. Basically, the base station issues a notification of time information using a DL beacon frame, and each of the terminals determines a wireless resource used for data frame transmission on the basis of time information acquired from the DL beacon frame.

A terminal unable to receive a DL beacon frame here is capable of determining a wireless resource used by the terminal for data frame transmission by acquiring time information described in a control frame received from a near terminal. Moreover, the base station is capable of calculating a wireless resource targeted for a reception process for receiving a data frame from a control frame received from a terminal under control by the base station, by acquiring information associated with a wireless resource used by the terminal for data frame transmission.

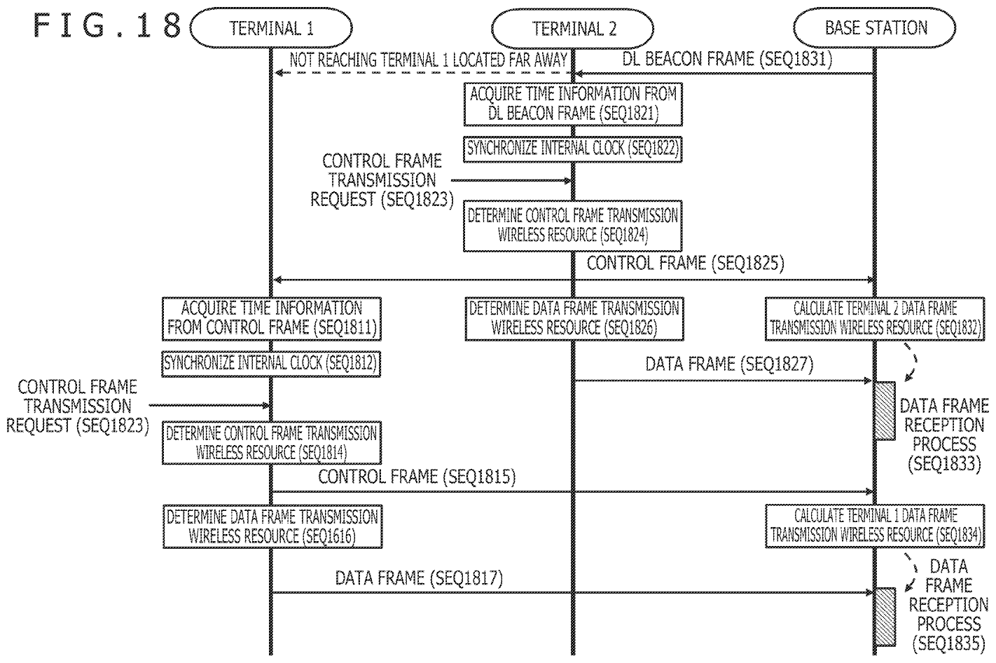

FIG. 18 depicts a communication sequence example of the wireless communication system depicted in FIG. 14. In this case, it is assumed that each of the terminals 1 and 2 has the device configuration depicted in FIG. 15, and that the base station has the device configuration depicted in FIG. 16.

The base station is able to receive a GPS signal, and calculates a current time with reference to time information acquired from the GPS signal, to thereby transmit a DL beacon frame which stores the current time using the wireless resource described above (SEQ1831).

The DL beacon frame is transmitted by broadcasting. Accordingly, all of the terminals located near the base station are able to receive the DL beacon frame. In the wireless communication system depicted in FIG. 14, the terminal 2 is able to receive the DL beacon frame from the base station. On the other hand, the DL beacon frame does not reach the terminal 1 located far from the base station.

The terminal 2 having received the DL beacon frame receives and demodulates the DL beacon frame to acquire the time information stored in the DL beacon frame (SEQ1821), and synchronizes the internal clock 108 within the terminal 2 on the basis of the acquired time information (SEQ1822).

Thereafter, the terminal 2 determines a wireless resource (time, frequency, and codes) used for control frame transmission in accordance with the method described above (SEQ1824) in response to reception of a control frame transmission request from an upper layer (SEQ1823).

Thereafter, the terminal 2 generates a control frame using calculated SYNC code and scramble code, and transmits the control frame at the determined time and frequency (SEQ1825). The terminal 2 transmits the control frame by broadcasting. Accordingly, the control frame of the terminal 2 is received by both the base station and the terminal 1.

The base station having received the control frame from the terminal 2 demodulates the control frame, and calculates a wireless resource (time, frequency, and codes) used by the terminal 2 for data frame transmission using a terminal ID stored in the control frame, and a time at which the control frame is received (SEQ1832).

Thereafter, the terminal 2 determines a wireless resource (time, frequency, and codes) used for data frame transmission (SEQ1826), and transmits a data frame at the determined time and frequency (SEQ1827).

When the time calculated on the basis of the control frame received from the terminal 2 comes, the base station receives a wireless signal at the calculated frequency, and detects and demodulates the data frame received from the terminal 2 using the calculated codes (SEQ1833).

On the other hand, the terminal 1 unable to receive a DL beacon frame from the base station receives and demodulates the control frame of the terminal 2, acquires time information stored in the control frame (SEQ1811), and synchronizes the internal clock 108 within the terminal 1 on the basis of the acquired time information (SEQ1812).

Thereafter, similarly to the terminal 2 able to receive a DL beacon frame, the terminal 1 determines a wireless resource (time, frequency, and codes) used for control frame transmission (SEQ1814), and transmits the control frame at the determined time and frequency by broadcasting (SEQ1815) in response to reception of a control frame transmission request from the upper layer (SEQ1813).

The base station having received the control frame from the terminal 1 demodulates the control frame, and calculates a wireless resource (time, frequency, and codes) used by the terminal 1 for data frame transmission using a terminal ID stored in the control frame and a time at which the control frame is received (SEQ1834).

Thereafter, the terminal 1 further determines the wireless resource (time, frequency, and codes) used for data frame transmission (SEQ1816), and transmits a data frame at the determined time and frequency (SEQ1817).

When the time calculated based on the control frame received from the terminal 1 comes, the base station receives a wireless signal at the calculated frequency, and detects and demodulates the data frame received from the terminal 1 using the calculated codes (SEQ1835).

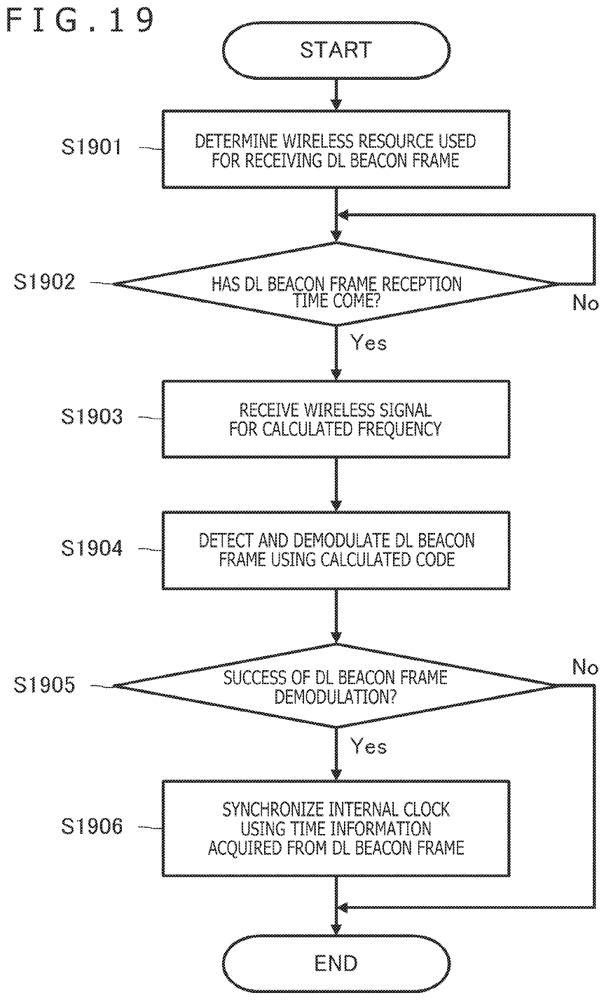

FIG. 19 presents a processing procedure in the form of a flowchart performed by a terminal for acquiring time information from a DL beacon frame. In this case, it is assumed that the terminal has the device configuration depicted in FIG. 15.

Initially, the terminal determines a wireless resource (time, frequency, and codes) used for DL beacon frame reception (step S1901). The DL beacon frame is transmitted at all transmittable frequencies for each time slot start time. Accordingly, the terminal may select any one time and frequency, and perform a reception process for receiving a DL beacon frame. In addition, the terminal may perform the reception process for all of these.

Subsequently, the terminal determines whether or not the DL beacon frame reception time determined in step S1901 has come (step S1902).

Thereafter, when the DL beacon frame reception time comes (Yes in step S1902), the terminal performs a reception process for receiving a wireless signal at the frequency determined in step S1901 (step S1903).

Subsequently, the terminal performs a process for detecting and demodulating a DL beacon frame using the codes determined in step S1901 (step S1904). Then, the terminal determines whether or not demodulation of the DL beacon frame has succeeded (step S1905).

In a case where demodulation of the DL beacon frame has succeeded (Yes in step S1905), the terminal synchronizes the internal clock 108 of the terminal using time information acquired from the DL beacon frame (step S1006), and ends the present process.

Moreover, in a case where demodulation of the DL beacon frame has failed (No in step S1005), the terminal ends the present process without synchronizing the internal clock 108 of the terminal.

Note that the terminal is not required to constantly perform the process presented in FIG. 19. For example, in a case where the terminal has succeeded the process presented in FIG. 19 once and completed synchronization of the internal clock, the terminal need not perform the process for a certain period of time.

Moreover, the terminal able to receive a DL beacon frame from the base station need not perform a processing operation for acquiring time information from a control frame of another terminal. Accordingly, the terminal may first perform a time information acquisition process using a DL beacon frame, and then perform a time information acquisition process (see FIG. 10) using a control frame of another terminal only in a case of a failure.

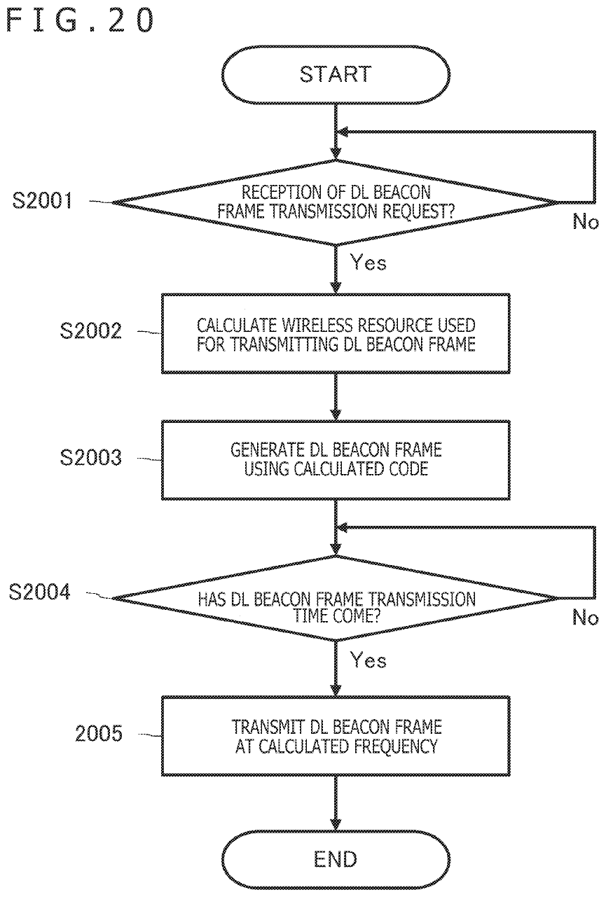

FIG. 20 presents a processing procedure in the form of a flowchart performed by a base station for transmitting a DL beacon frame.

Initially, the base station determines whether or not a DL beacon frame transmission request has been received from an upper layer (step S2001).

In a case where a DL beacon frame transmission request has been received (Yes in step S1101), the base station determines a wireless resource (time, frequency, and codes) used for DL beacon frame transmission (step S2002).

Subsequently, the base station generates a DL beacon frame using the codes determined in step S2002 (step S2003). Thereafter, the base station determines whether or not the DL beacon frame transmission time determined in step S2002 has come (step S2004).

When the DL beacon frame transmission time comes (Yes in step S2004), the base station transmits the DL beacon frame at the frequency determined in step S2002 (step S2005), and ends the present process.

Note that the terminal is similarly capable of receiving a control frame in accordance with the processing procedure presented in FIG. 10, and also transmitting a control frame and a data frame in accordance with the processing procedure presented in FIG. 11 in the second embodiment. Moreover, the base station is capable of receiving a control frame from the terminal in accordance with the processing procedure presented in FIG. 12, and receiving a data frame from the terminal in accordance with the processing procedure presented in FIG. 13.

For example, in the communication sequence example presented in FIG. 18, the terminal 2 notifies the base station or the terminal 1 located nearby of time information acquired from a DL beacon frame using a control frame in accordance with the processing procedure presented in FIG. 19 as information associated with a wireless resource used by the terminal 2 for data frame transmission. In addition, the terminal 2 determines the wireless resource used by the terminal 2 for data frame transmission in accordance with the method described above on the basis of the time information acquired from the DL beacon frame. On the other hand, the terminal 1 unable to receive a DL beacon frame is capable of performing sequential control frame and data frame transmission by acquiring time information from the control frame of the terminal 2 in accordance with the processing procedure presented in FIG. 10, determining a wireless resource used by the terminal 1 for data frame transmission on the basis of the time information, and performing the processing procedure presented in FIG. 11.

Moreover, the base station is capable of acquiring a terminal ID and a control frame reception time from a control frame received from each of terminals under control by the base station (terminals 1 and 2) by performing the processing procedure presented in FIG. 12 as information associated with a wireless resource used by the respective terminals for data frame transmission. Thereafter, the base station is capable of receiving a data frame by performing the processing procedure presented in FIG. 13 in accordance with the method described above on the basis of the terminal ID and the control frame reception time acquired from the control frame of each of the terminals.

As described above, according to the second embodiment, a terminal able to receive a DL signal from a base station first achieves time synchronization using a DL beacon frame transmitted from the base station even when no terminal able to receive a GPS signal is present within the wireless communication system. Subsequently, a terminal located far and unable to receive a DL signal from the base station achieves time synchronization using a control frame transmitted from the terminal having received the DL beacon frame and achieved time synchronization. In this manner, even an asymmetric communication system is capable of achieving time synchronization, and autonomously selecting a wireless resource allowing avoidance of a collision with a frame transmitted from another terminal and allowing separation.

### Embodiment 3

According to the first and second embodiments described above, a wireless resource used for data frame transmission is determined using a control frame transmission time. It is therefore assumed that one data frame is transmitted for each control frame.

However, in this communication procedure, there arises a problem that the number of times of control frame transmission increases. Moreover, in a case of a failure of control frame reception by a base station, there is produced such a disadvantage that a wireless resource used for data frame transmission is unknown.

Accordingly, proposed in a third embodiment is a method which solves the above disadvantages by using a data frame transmission request time for determining a wireless resource used for data frame transmission.

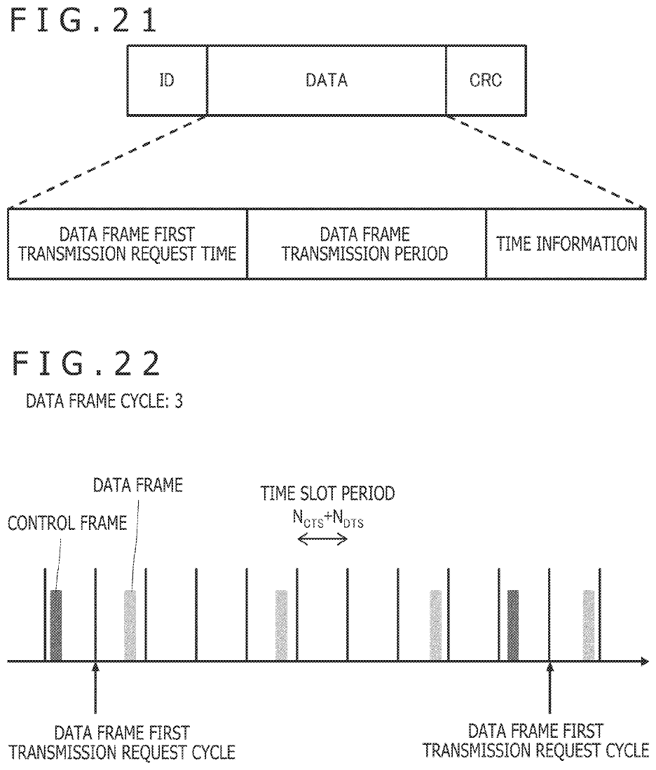

A frame configuration in the third embodiment is similar to the frame configuration of the first embodiment. FIG. 21 depicts a frame configuration example of a DATA portion of a control frame in the third embodiment. The DATA portion depicted in this figure stores a data frame first transmission request time, a data frame transmission period, and time information.

The data frame first transmission request time is a time at which transmission of a data frame is first requested after transmission of a control frame. The data frame first transmission request time indicates a time of an initial time slot in a time slot period where N_{CTS}+N_{DTS} time slots constitute one cycle.

The data frame transmission period is a period in which a data frame transmission request is issued. The data frame transmission period is represented by N_{CTS}+N_{DTS} time slots constituting one unit.

The time information is a current time acquired by the internal clock 108 within a terminal.

A wireless resource determination method used for data frame transmission in the present embodiment will next be described.

The data frame transmission time is determined using the pseudorandom number generator depicted in FIG. 5 similarly to the first embodiment. Initial values set for the respective M sequences including an M-Sequence 1 and an M-Sequence 2 are a terminal ID, and a time at which a data frame transmission request is issued from the corresponding terminal, respectively. A data frame transmission request time Tₜₓ is calculated using following Equation (5).

[Math. 5]

Tₜₓ=T_{first}+L_{period}×N_{txperiod}×n (5)

Note that the followings are set in Equation (5) described above. Specifically, Tₜₓ is a data frame transmission request time, T_{first} is a data frame first transmission request time, L_{period} is a length of one cycle (i.e., L_{period}=Lₜₛ×(N_{CTS}+N_{DTS})), N_{txperiod} is a data frame transmission period (unit: time slot period), and n is the number of times of data frame transmission (indicating how many times data frame transmission has been carried out).

In addition, a control frame transmission period is set to a period P_{Ctx} calculated by following Equation (6) so as to calculate a wireless resource used for data frame transmission even in a case of a failure of control frame reception by the base station.

[Math. 6]

P_{Ctx}=N_{Dtx}×N_{txperiod} (6)

Note that the followings are set in Equation (6) described above. Specifically, P_{Ctx} is a control frame transmission period (unit: time slot period), N_{Dtx} is the number of data frames successively transmitted for one control frame, and N_{txperiod} is a data frame transmission period (unit: time slot period).

FIG. 22 depicts a state of transmission of a control frame and a data frame in the wireless communication system according to the present embodiment. Note that a horizontal axis in this figure represents a time axis.

In this case, N_{Dtx}=3 is set, and the terminal successively transmits three data frames for one control frame.

The DATA portion of the control frame describes a time of an initial time slot in a time slot cycle subsequent to previous transmission of a control frame, and a data frame transmission period N_{txperiod}=3 as a data frame first request transmission time. Accordingly, the control frame transmission period P_{Ctx} is calculated as P_{Ctx}=9 in accordance with Equation (6) described above.

Description of details of a communication sequence performed in the wireless communication system in the present embodiment is omitted. Each of the terminals receives a GPS signal or a DL beacon frame coming from the base station, achieves time synchronization, and determines a wireless resource used for data frame transmission. Moreover, a terminal unable to receive a GPS signal or a DL beacon frame from the base station is capable of acquiring time information from a control frame of a near terminal in accordance with the processing procedure presented in FIG. 10. In either case, the terminal successively transmits a plurality of data frames for one control frame on the basis of time information for which synchronization has been achieved.

Moreover, the base station is capable of performing a reception process for receiving a plurality of data frames by acquiring, from a control frame received from each of terminals under control by the base station, information associated with a data frame first transmission request time and a data frame transmission period as well as a terminal ID and a control frame reception time as information associated with a wireless resource used by each of the terminals for transmission of the plurality of data frames.

As described above, according to the third embodiment, the base station knows a data frame transmission request time and a terminal ID subsequently transmitted even in a case of a failure of reception of a control frame regularly transmitted from the terminal after a success in reception of a control frame transmitted from a terminal once and acquisition of the terminal ID and a transmission time and a transmission period of the data frame. Accordingly, the base station is capable of calculating a wireless resource (time, frequency, and codes) used for data frame transmission, and thus achieves reception and demodulation of the data frame.

### Embodiment 4

Described above in the first to third embodiments has been a method which achieves time synchronization within the wireless communication system, and determines a wireless resource using a pseudorandom number on the basis of time information and a terminal ID to select a wireless resource allowing avoidance between a transmission frame of a terminal and a transmission frame of another terminal, or allowing separation.

On the other hand, proposed in a fourth embodiment is a method which shares a wireless resource scheduled to be used (for data frame transmission) by using a control frame to select a wireless resource allowing avoidance between a transmission frame of a terminal and a transmission frame of another terminal or allowing separation without the necessity of time synchronization.

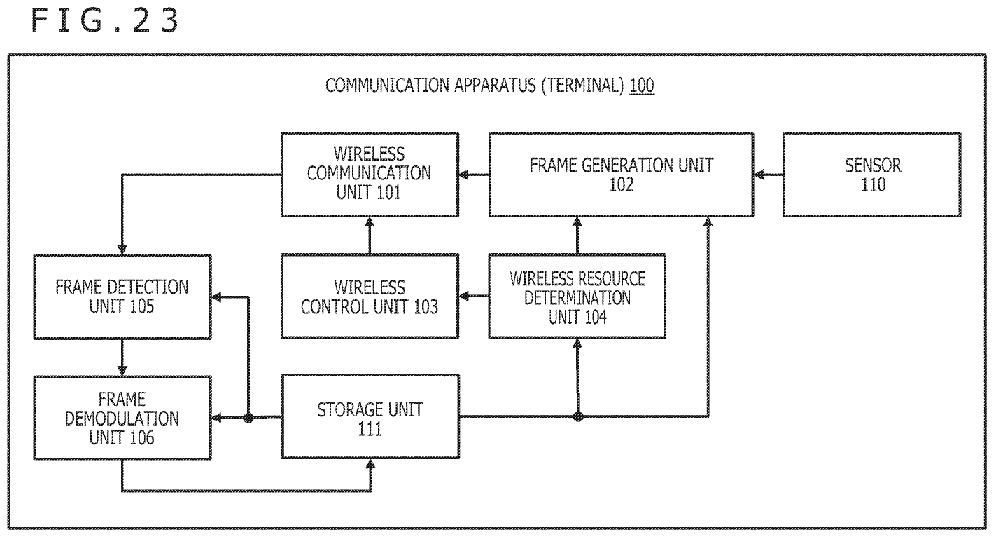

FIG. 23 depicts a configuration example of the communication apparatus 100 operating as a terminal in the present embodiment. For example, the communication apparatus 100 is assumed to operate as a sensor terminal in a wireless sensor network. The communication apparatus 100 depicted in the figure includes the wireless communication unit 101, the frame generation unit 102, the wireless control unit 103, the wireless resource determination unit 104, the frame detection unit 105, the frame demodulation unit 106, the sensor 110, and the storage unit 111.

The wireless communication unit 101 converts a frame generated by the frame generation unit 102 into a wireless signal, and transmits the wireless signal under control by the wireless control unit 103. Moreover, the wireless communication unit 101 receives a radio wave, converts the radio wave into a wireless signal, and passes the wireless signal to the frame detection unit 105 under control by the wireless control unit 103.

The frame generation unit 102 generates a control frame and a data frame using codes determined by the wireless resource determination unit 104. The frame generation unit 102 generates a control frame which stores information indicating a wireless resource scheduled to be used. Moreover, in a case where the communication apparatus 100 operates as a sensor terminal in the wireless sensor network, the frame generation unit 102 generates a data frame containing information (sensor data) associated with the outside or the inside of the sensor terminal and acquired by the sensor 110 described later.

The wireless control unit 103 controls the wireless communication unit 101 in such a manner as to transmit a control frame and a data frame at a transmission time and a transmission frequency obtained by the wireless resource determination unit 104. Moreover, in a case where a control frame of a terminal located nearby needs to be received, the wireless control unit 103 controls the wireless communication unit 101 in such a manner as to perform a reception process at a transmission frequency of a control frame obtained from the storage unit 111.

The wireless resource determination unit 104 determines a time, a frequency, and codes (SYNC code and scramble code) at which a control frame and a data frame are transmitted. Moreover, the wireless resource determination unit 104 determines a time, a frequency, and codes by using methods different for each of a control frame and a data frame.

The frame detection unit 105 detects a frame containing a control frame from a reception signal received by the wireless communication unit 101. Specifically, the frame detection unit 105 extracts a signal at a targeted frequency from a broadband signal, generates a known sequence from a SYNC code and a scramble code acquired from the storage unit 111, calculates a correlation value between the known sequence and a reception signal, and determines that a frame has been detected in a case where the correlation value becomes a fixed value or larger. The frame detection unit 105 passes the detected time to the frame demodulation unit 106 in a case where detection of a control frame has succeeded.

The frame demodulation unit 106 cancels scrambling using a scramble code acquired from the storage unit 111, on the basis of a time detected by the frame detection unit 105. Thereafter, the frame demodulation unit 106 extracts a payload portion of the received frame and performs a demodulation process for demodulating an error correction code, and an error detection process using CRC. Moreover, in a case of a demodulation success of a control frame, the frame demodulation unit 106 causes the storage unit 111 to store wireless resource information contained in the control frame.

The sensor 110 includes a sensor element equipped in the communication apparatus 100 functioning as a sensor terminal to acquire information associated with the outside or the inside of the sensor terminal and given as a notification using a data frame. For example, the sensor 110 includes a temperature sensor and an acceleration sensor.

The storage unit 111 retains wireless resource information necessary for detection and demodulation of a control frame. Moreover, the storage unit 111 retains a database indicating whether or not wireless resources are scheduled to be used in addition to information regarding wireless resources (time, frequency, and codes) available for data frame transmission, and wireless resource information acquired from a control frame and used by a near terminal.

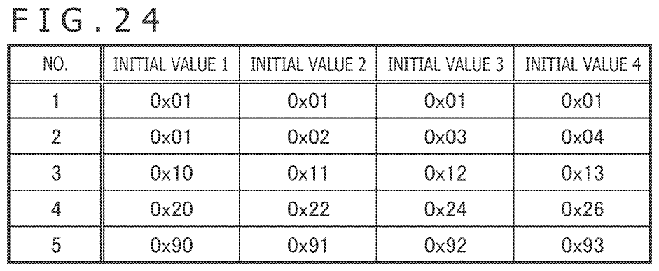

FIG. 24 depicts a configuration example of a combination database of initial values used for generation of a SYNC code and a scramble code, and retained by the storage unit 111 of the terminal 100 according to the present embodiment.

The SYNC code and the scramble code are generated using the pseudorandom number generators depicted in FIGS. 6 and 7, respectively, similarly to the first embodiment. Combinations of initial values input to these pseudorandom number generators are common values within the wireless communication system in consideration of a processing volume of the base station. All the terminals and the base station retain the database depicted in FIG. 24.

It is assumed that reference signs used within the wireless communication system according to the present embodiment are represented by numbers given to the database depicted in FIG. 24.

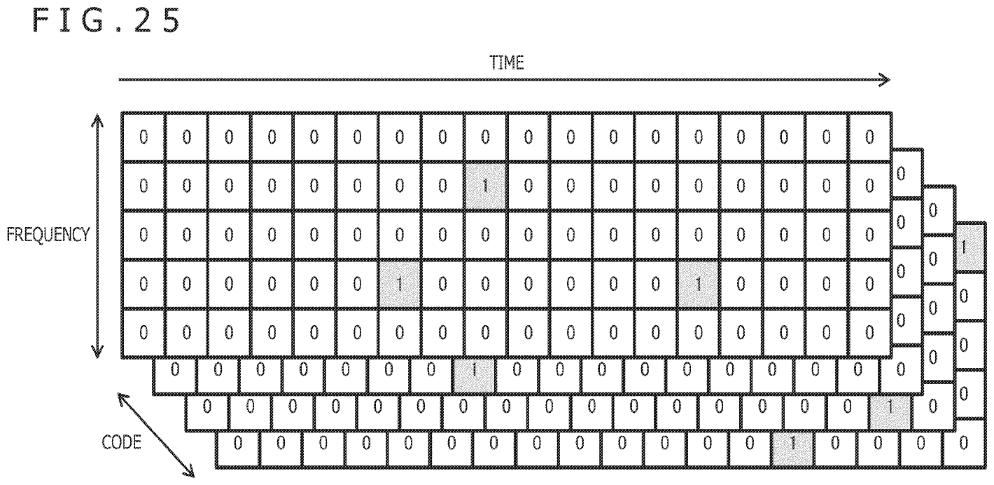

FIG. 25 depicts a configuration example of a wireless resource use schedule database retained by the storage unit 111 of the terminal 100 according to the present embodiment. In this figure, a horizontal axis represents a time axis, a vertical axis represents a frequency axis, and a code axis is set in a depth direction. The wireless resource use schedule database is a list of wireless resources (time, frequency, and codes) available for data frame transmission. The wireless resource use schedule database depicted in the figure includes tables each retaining whether or not each of wireless resources is scheduled to be used in the form of a combination of a time slot, a channel, and a coding system. According to the example depicted in the figure, a value “1” is retained for a wireless resource scheduled to be used by a near terminal, and a value “0” is retained for a wireless resource not scheduled to be used.

Concerning the time axis, time synchronization is not achieved within the wireless communication system. Accordingly, management based on a time slot as in the first embodiment is not allowed. Accordingly, the time axis is sectioned at regular intervals of a certain period of time (e.g., one millisecond), and use of a wireless resource is determined for a transmission start time.

The frequency axis is managed on the basis of a frequency channel number available for data frame transmission.

The code axis is managed on the basis of an initial value combination database number for code generation described above (see FIG. 24).

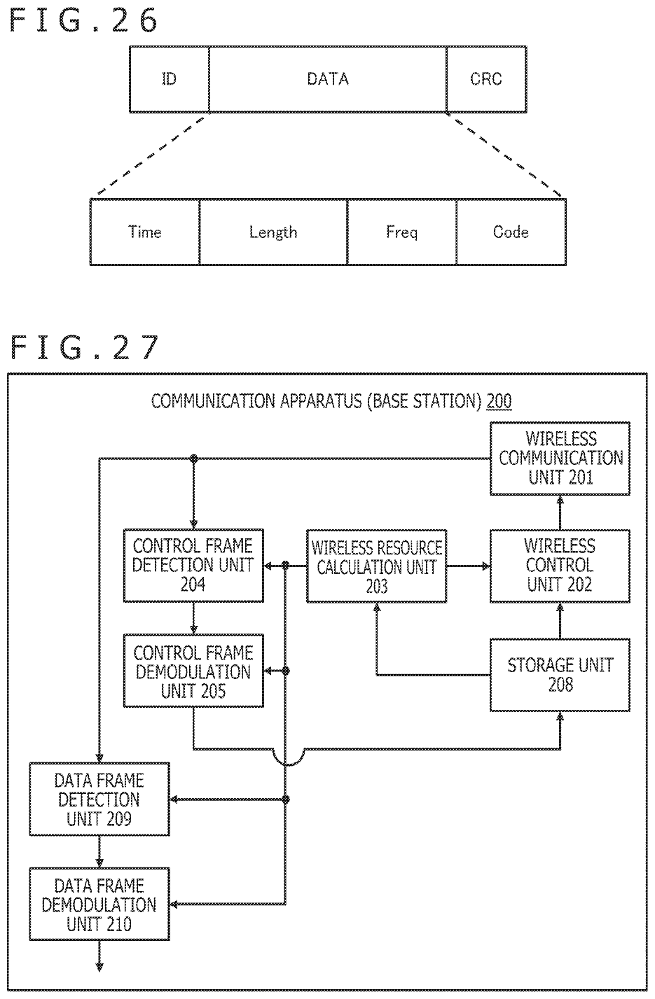

A frame configuration in the fourth embodiment is similar to the frame configuration of the first embodiment. FIG. 26 depicts a frame configuration example of a DATA portion of a control frame in the fourth embodiment. The DATA portion depicted in this figure includes respective fields of Time, Length, Freq, and Code.

The Time field stores a data frame transmission start time. This field describes an elapsed time from a time of transmission of a corresponding control frame as information indicating a data frame transmission start time.

The Length field stores information indicating a data frame time length.

The Freq field stores a data frame transmission frequency. This field describes a frequency channel number used for transmission as information indicating a data frame transmission frequency.

The Code field stores a code used for data frame transmission. This field describes an initial value combination database number for code generation (see FIG. 24) as information indicating a code used for data frame transmission.

FIG. 27 depicts a configuration example of the communication apparatus 200 operating as a base station in the present embodiment. For example, it is assumed that the communication apparatus 200 performs an operation for receiving a data frame containing sensor data from respective sensor terminals in the wireless sensor network. The communication apparatus 200 depicted in the figure includes the wireless communication unit 201, the wireless control unit 202, the wireless resource calculation unit 203, the control frame detection unit 204, the control frame demodulation unit 205, the storage unit 208, the data frame detection unit 209, and the data frame demodulation unit 210.

The wireless communication unit 201 receives a wireless signal. The wireless communication unit 201 receives a radio wave and converts the radio wave into a wireless signal under control by the wireless control unit 202. Thereafter, in a case where an instruction from the wireless control unit 202 is reception of a control frame, the wireless communication unit 201 passes a reception signal to the control frame detection unit 204. In a case where an instruction from the wireless control unit 202 is reception of a data frame, the wireless communication unit 201 passes a reception signal to the data frame detection unit 209. Note that the wireless communication unit 201 may transmit a wireless signal. However, description of details of this point is omitted.

The wireless control unit 202 controls the wireless communication unit 201 in such a manner as to receive a data frame at a time and a frequency at which the data frame is transmitted with reference to the wireless resource use schedule database (see FIG. 25) retained by the storage unit 208. A control frame is transmitted at any time and frequency. Accordingly, the wireless control unit 202 controls the wireless communication unit 201 in such a manner as to constantly perform a reception process for all frequencies available for control frame transmission.

The storage unit 208 retains wireless resource information necessary for detection and demodulation of a control frame. Moreover, similarly to the storage unit 111 of the communication apparatus 100 (see FIG. 23) operating as a terminal, the storage unit 208 retains a database (see FIG. 25) indicating whether or not wireless resources are scheduled to be used in addition to information regarding wireless resources (time, frequency, and codes) available for data frame transmission, and wireless resource information acquired from a control frame and used by a near terminal.

The wireless resource calculation unit 203 calculates a time, a frequency, and codes (SYNC code and scramble code) at which a control frame, and a data frame of a terminal whose terminal ID has been registered beforehand are transmitted. The wireless resource calculation unit 203 calculates the time, the frequency, and the codes by using methods different for each of the control frame and the data frame (described above).

The control frame detection unit 204 detects a control frame from a reception signal received by the wireless communication unit 201. Specifically, the control frame detection unit 204 extracts a signal at a targeted frequency from a broadband signal, generates a known sequence from a SYNC code and a scramble code calculated by the wireless resource calculation unit 203, calculates a correlation value between the known sequence and a reception signal, and determines that a control frame has been detected in a case where the correlation value becomes a fixed value or larger. The control frame detection unit 204 passes the detected time to the control frame demodulation unit 205 in a case where detection of a control frame has succeeded.

The control frame demodulation unit 205 demodulates a reception signal into a control frame. Specifically, the control frame demodulation unit 205 cancels scrambling using a scramble code acquired from the wireless resource calculation unit 203, on the basis of a time detected by the control frame detection unit 204. Thereafter, the control frame demodulation unit 205 extracts a payload portion of the received frame, and performs a demodulation process for demodulating an error correction code, and an error detection process using CRC. Subsequently, in a case of a success of demodulation of a control frame, the control frame demodulation unit 205 extracts wireless resource information (time, frequency, and codes) scheduled to be used from the control frame, and stores the extracted control frame in the storage unit 208.

The data frame detection unit 209 detects a data frame from a reception signal received by the wireless communication unit 201. Specifically, the data frame detection unit 209 extracts a signal at a targeted frequency from a broadband signal, generates a known sequence from a SYNC code and a scramble code calculated by the wireless resource calculation unit 203, calculates a correlation value between the known sequence and a reception signal, and determines that a data frame has been detected in a case where the correlation value becomes a fixed value or larger. The data frame detection unit 209 passes the detected time to the data frame demodulation unit 210 in a case where detection of a data frame has succeeded.

The data frame demodulation unit 210 demodulates a reception signal into a control frame. Specifically, the data frame demodulation unit 210 cancels scrambling using a scramble code acquired from the wireless resource calculation unit 203, on the basis of a time detected by the data frame detection unit 209. Thereafter, the data frame demodulation unit 210 extracts a payload portion of the received frame and performs a demodulation process for demodulating an error correction code, and an error detection process using CRC. Subsequently, in a case where demodulation of a data frame has succeeded, the data frame demodulation unit 210 notifies an upper layer application or the like of reception data such as sensor data contained in the data frame.

Subsequently described will be a wireless resource determination method used for transmission of a control frame and a data frame in the present embodiment.

A wireless resource determination method used for transmission of a control frame will be initially described.

Any time is selected as a control frame transmission time.

Moreover, any frequency is selected from frequencies available for control frame transmission as a control frame transmission frequency. For example, this frequency may be randomly selected.

Furthermore, it is assumed that a SYNC code and a scramble code for a control frame are common codes within the wireless communication system. The SYNC code and the scramble code are generated using pseudorandom number generators similarly to the first embodiment described above. Each of the pseudorandom number generators depicted in FIGS. 6 and 7 is a gold code generator using two M sequences. Values set as initial values 1 to 4 are common within the wireless communication system, retained in the storage unit 111 within the terminal, and determined beforehand.

A wireless resource determination method used for data frame transmission will next be described.

A time, a frequency, and codes used for data frame transmission are determined in such a manner as not to overlap with those of a wireless resource scheduled to be used by another terminal with reference to the wireless resource use schedule database (see FIG. 25).

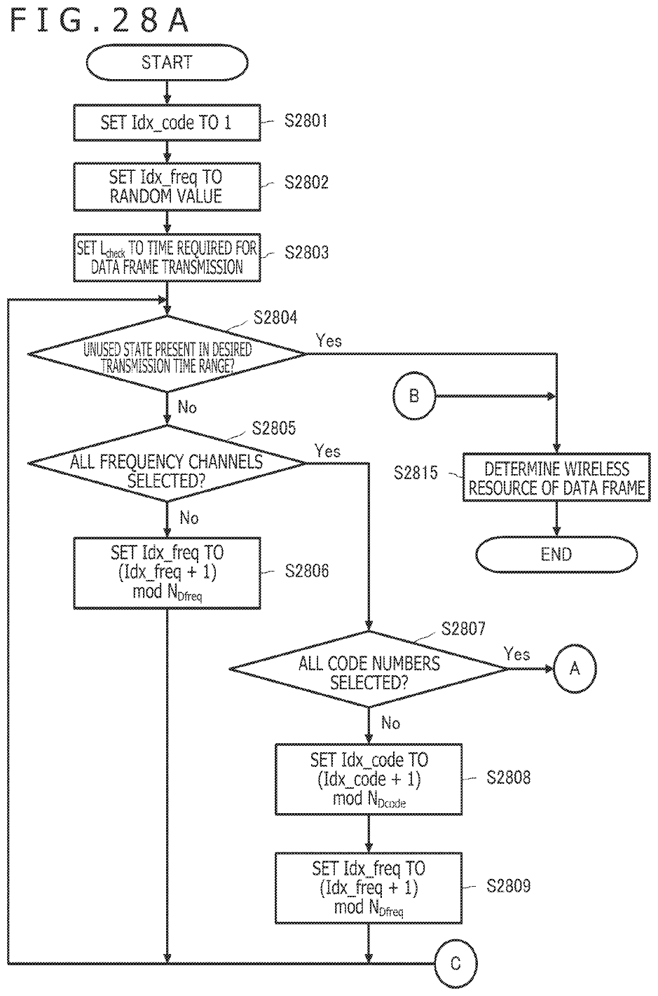

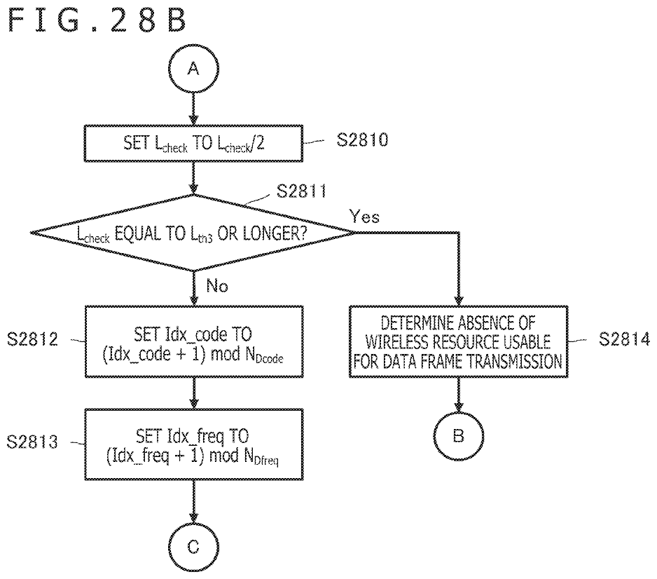

FIGS. 28A and 28B each present a processing procedure in the form of a flowchart performed by the communication apparatus 100 operating as a terminal to determine a wireless resource used for data frame transmission.

Initially, index Idx_code of a code number is set to 1 (step S2801), index Idx_freq of a channel number is set to a random value in a range from 0 (inclusive) to less than N_{Dfreq} (step S2802), and L_{check} is set to a time required for transmission of a data frame (step S2803). N_{Dfreq} indicates the number of channels available for a data frame. In addition, L_{check} indicates a length (time) for determining that a wireless resource is available.

Subsequently, it is determined whether or not a state at a code and a frequency having a code number of Idx_code and a channel number of Idx_freq+F_{Doffset} is an unused state for L_{check} or longer in a period from a control frame transmission schedule time to a range from Lₜₕ₁ (inclusive) to Lₜₕ₂ (inclusive) with reference to the wireless resource use schedule database (step S2804). F_{Doffset} is a channel offset of a data frame transmission frequency, while each of Lₜₕ₁ and Lₜₕ₂ is a threshold indicating a range of a transmission time at which a data frame is desired to be transmitted. Each of Lₜₕ₁ and Lₜₕ₂ may be a common value within the wireless communication system, or may be different for each terminal.

In a case where the state at the corresponding code and frequency is the unused state for L_{check} or longer in the period from the control frame transmission schedule time to the range from Lₜₕ₁ (inclusive) to Lₜₕ₂ (inclusive) (Yes in step S2804), the code number is set to Idx_code, the channel number of the frequency is set to Idx_freq+F_{Doffset}, and the transmission start time is set to an earliest time at which the state at the code and the frequency becomes the unused state for L_{check} or longer in the period from the current time to the range from Lₜₕ₁ (inclusive) to Lₜₕ₂ (inclusive) in the wireless resource used for data frame transmission (step S2815), and the present process ends.

On the other hand, in a case where the state at the corresponding code and frequency is not the unused state for L_{check} or longer in the period from the control frame transmission schedule time to the range from Lₜₕ₁ (inclusive) to Lₜₕ₂ (inclusive) (No in step S2804), the channel number is changed to one larger number (step S2806) when wireless resource availability checking is not completed yet for all of the frequency channels (No in step S2805). In this case, the process returns to step S2804 to perform similar wireless resource availability checking.

In a case where no available wireless resource is found by wireless resource availability checking for all of the frequency channels (Yes in step S2805), each of the code number and the channel number is changed to one larger number (step S2808, step S2809) when wireless resource availability checking is not yet completed for all of the code numbers (No in step S2807). In this case, the process returns to step S2804 to perform similar wireless resource availability checking.

Moreover, in a case where no available wireless resource is found by wireless resource availability checking for all of the code numbers (Yes in step S2807), the length L_{check} for determining availability of a wireless resource is set to a half length of L_{check} (step S2810).

It is determined here whether or not L_{check} newly set is Lₜₕ₃ or longer (step S2811). When L_{check} is Lₜₕ₃ or longer (Yes in step S2811), each of the code number and the channel number is changed to one larger number (step S2812, step S2813). Thereafter, the process returns to step S2804 to perform similar wireless resource checking availability for all of the frequency channels and the codes using L_{check} newly set.

Lₜₕ₃ here is a length of a period for which at least a collision is desired to be avoided in transmission of a data frame. For example, in a case where a collision is desired to be avoided for at least a quarter of the length of the data frame, Lₜₕ₃ is set to a quarter of the time required for transmission of the data frame.

On the other hand, in a case where L_{check} is Lₜₕ₃ or shorter (No in step S2811), wireless resource availability checking ends. In this case, it is determined that no wireless resource available for data frame transmission is present (step S2814), and the present process ends.

According to the wireless communication system of the present embodiment, each of the terminals transmits a data frame containing sensor data, while the base station collects sensor data from each of the terminals. Each of the terminals is configured to transmit a control frame (see FIG. 26) beforehand to give a notification of information associated with a wireless resource used for data frame transmission and containing a data frame start transmission time, a data frame time length, a data frame transmission frequency, and codes used for data frame transmission. Accordingly, the base station is capable of performing a data frame reception process on the basis of a wireless resource described in a control frame received from the terminal. Moreover, each of the terminals determines a wireless resource used by the terminal itself for data frame transmission such that the wireless resource does not overlap with a wireless resource described in a control frame received from another terminal.

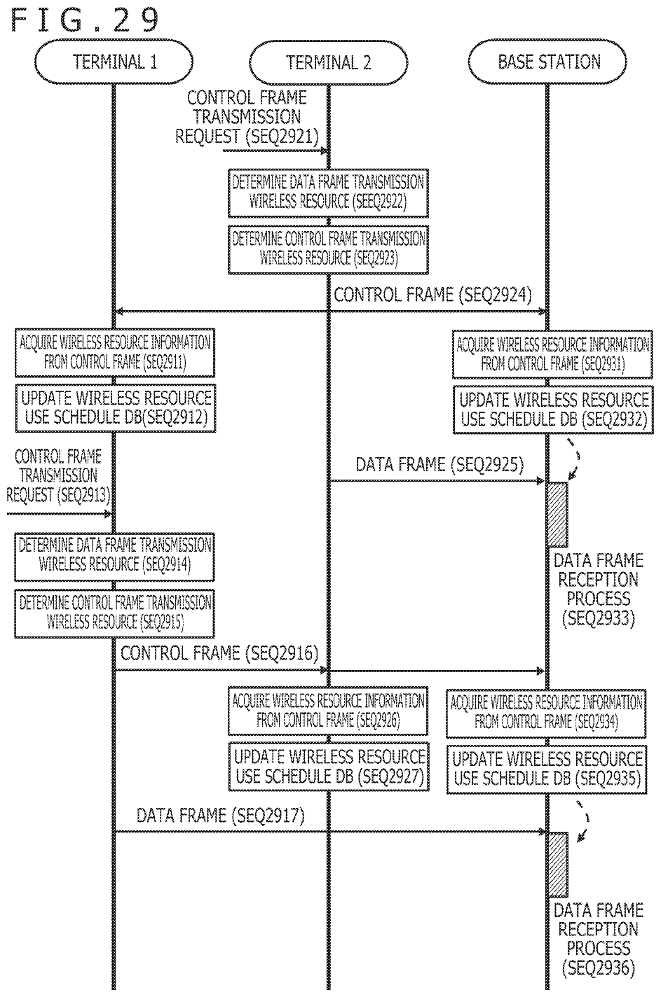

FIG. 29 depicts a communication sequence example of the wireless communication system according to the present embodiment. In this case, it is assumed that each of the terminals 1 and 2 has the device configuration depicted in FIG. 23, and that the base station has the device configuration depicted in FIG. 27.

In response to reception of a control frame transmission request from an upper layer (SEQ2921), the terminal 2 determines a wireless resource (time, frequency, and codes) used for data frame transmission in accordance with the processing procedure presented in FIGS. 28A and 28B with reference to the wireless resource use schedule database (see FIG. 25) (SEQ2922).

Subsequently, the terminal 2 determines a wireless resource (time, frequency, and codes) used for control frame transmission (SEQ2923). As described above, the terminal 2 selects any transmission time, and any frequency from frequencies available for control frame transmission, and determines codes using pseudorandom number generators. Thereafter, the terminal 2 transmits a control frame using the determined wireless resource (SEQ2924).

The terminal 2 transmits the control frame by broadcasting. Accordingly, the control frame transmitted from the terminal 2 is received by both the base station and the terminal 1.

The base station having received the control frame from the terminal 2 receives and demodulates the control frame, acquires information associated with a transmission start time, a time length, a frequency, and codes of a data frame used by the terminal 2 and stored in the control frame (SEQ2931), and updates a wireless resource use schedule database managed by the storage unit 208 of the terminal 2 (SEQ2932).

Moreover, the terminal 1 having received the control frame from the terminal 2 also receives and demodulates the control frame, acquires information associated with a transmission start time, a time length, a frequency, and codes of a data frame used by the terminal and stored in the control frame (SEQ2911), and updates a wireless resource use schedule database managed by the storage unit 111 of the terminal 1 (SEQ2912).

Thereafter, the terminal 2 transmits a data frame using the frequency and the codes determined above when the determined data frame transmission start time comes (SEQ2925).

The base station performs a reception process for receiving the data frame from the terminal 2 using the transmission start time, the time length, the frequency, and the codes of the data frame acquired from the control frame from the terminal 2 (SEQ2933).

Moreover, in response to reception of a control frame transmission request from the upper layer (SEQ2913), the terminal 1 determines a wireless resource (time, frequency, and codes) used for data frame transmission in accordance with the processing procedure presented in FIGS. 28A and 28B with reference to the wireless resource use schedule database (SEQ2914).

Subsequently, the terminal 1 determines a wireless resource (time, frequency, and codes) used for control frame transmission (SEQ2915). As described above, the terminal 1 selects any transmission time, and any frequency from frequencies available for control frame transmission, and determines codes using pseudorandom number generators. Thereafter, the terminal 1 transmits a control frame using the determined wireless resource (SEQ2916).

The terminal 1 transmits the control frame by broadcasting. Accordingly, the control frame of the terminal 1 is received by both the base station and the terminal 2.

The base station having received the control frame from the terminal 1 receives and demodulates the control frame, acquires information associated with a transmission start time, a time length, and codes of a data frame used by the terminal and stored in the control frame (SEQ2934), and updates a wireless resource use schedule database managed by the storage unit 208 of the base station (SEQ2935).

Moreover, the terminal 2 having received the control frame from the terminal 1 also receives and demodulates the control frame, acquires information associated with a transmission start time, a time length, and a code of a data frame used by the terminal and stored in the control frame (SEQ2926), and updates a wireless resource use schedule database managed by the storage unit 111 of the terminal 2 (SEQ2927).

Thereafter, the terminal 1 transmits the data frame using the frequency and the codes determined above when the determined data frame transmission start time comes (SEQ2917).

The base station performs a reception process for receiving the data frame from the terminal 2 using the transmission start time, the time length, the frequency, and the codes of the data frame acquired from the control frame from the terminal 2 (SEQ2936).

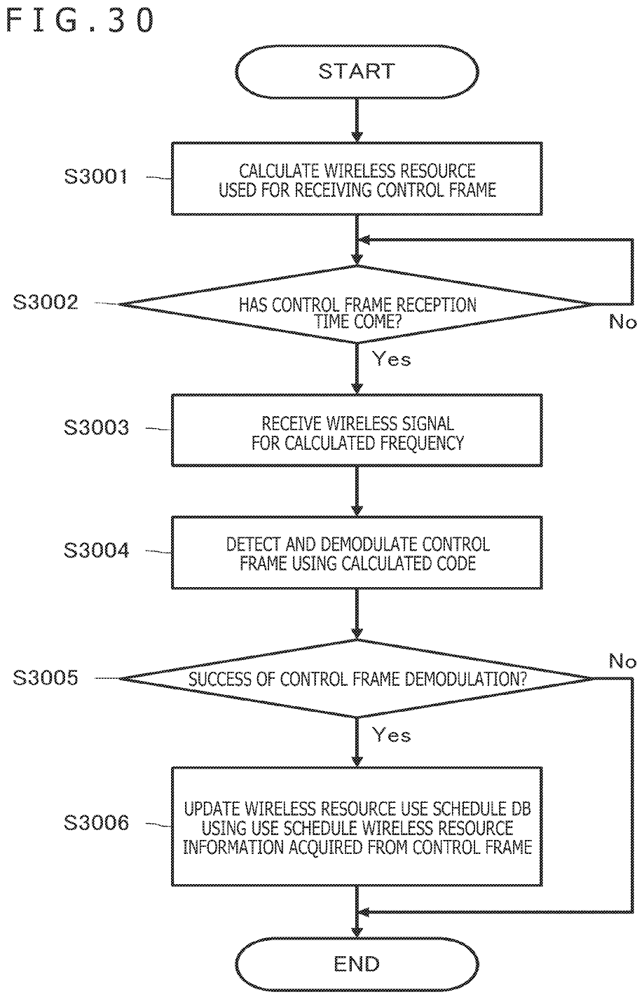

FIG. 30 presents a processing procedure in the form of a flowchart performed by a terminal for acquiring wireless resource information scheduled to be used by another terminal.

Initially, the terminal calculates a wireless resource (time, frequency, and codes) used for control frame reception from another terminal (step S3001). It is difficult to recognize beforehand a time and a frequency at which a control frame is transmitted from another terminal. Accordingly, a reception process is basically performed for all times (all time slots) and frequencies available for control frame transmission.

Subsequently, the terminal calculates whether or not the control frame reception time determined in step S3001 has come (step S3002).

Thereafter, when the control frame reception time comes (Yes in step S3002), the terminal performs a reception process for receiving a wireless signal at the frequency calculated in step S3001 (step S3003).

Subsequently, the terminal performs a process for detecting and demodulating the control frame using the codes calculated in step S3001 (step S3004). Then, the terminal determines whether or not demodulation of the control frame has succeeded (step S3005).

In a case where demodulation of the control frame has succeeded (Yes in step S3005), the terminal updates a wireless resource use schedule database managed by the storage unit 111 of the terminal using the wireless resource information scheduled to be used and acquired from the control frame (step S3006), and ends the present process.

Moreover, in a case where demodulation of the control frame has failed (No in step S3005), the terminal ends the present process without updating the wireless resource use schedule database managed by the storage unit 111 of the terminal.

For example, in a communication sequence presented in FIG. 29, each of the terminals 1 and 2 performs a reception process for receiving a control frame from another terminal, and updates a wireless resource use schedule database in accordance with the processing procedure presented in FIG. 30.

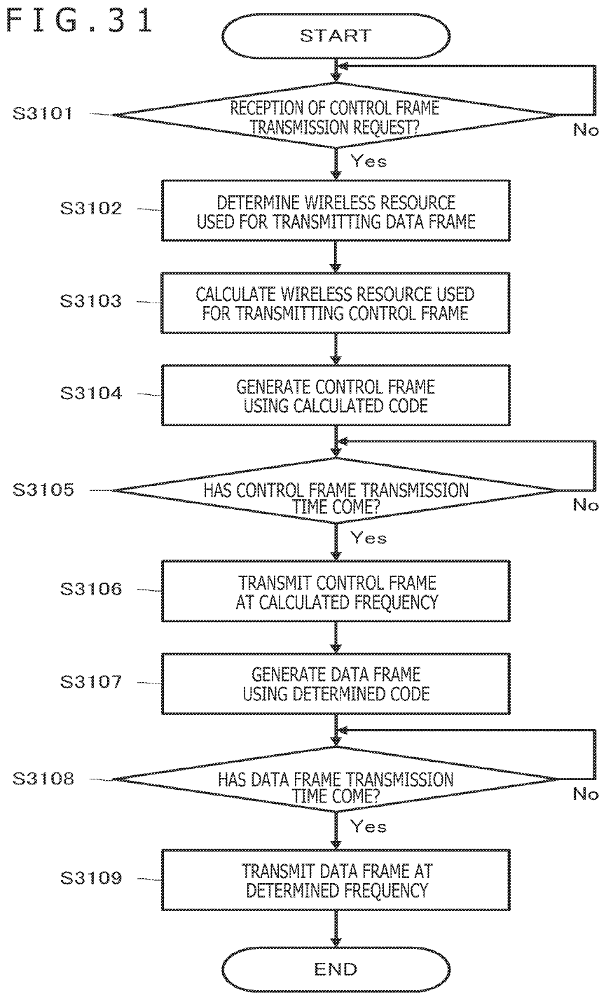

FIG. 31 presents a processing procedure in the form of a flowchart performed by a terminal for transmitting a control frame and a data frame. It is assumed here that the terminal transmits one data frame for each control frame. In addition, it is assumed that the terminal has the device configuration depicted in FIG. 23.

Initially, the terminal determines whether or not a control frame transmission request has been received from an upper layer (step S3101).

In a case where a control frame transmission request has been received (Yes in step S3101), the terminal determines a wireless resource (time, frequency, and codes) used for data frame transmission in accordance with the processing procedure presented in FIGS. 28A and 28B (step S3102).

Subsequently, the terminal calculates a wireless resource (time, frequency, and codes) used for control frame transmission (step S3103). As described above, the terminal selects any transmission time, and any frequency from frequencies available for control frame transmission, and determines codes using pseudorandom number generators.

Subsequently, the terminal generates a control frame using the codes determined in step S3103 (step S3104). Thereafter, the terminal determines whether or not the control frame transmission time determined in step S3102 has come (step S3105).

When the control frame transmission time comes (Yes in step S3105), the terminal transmits a control frame at the frequency calculated in step S3103 (step S3106).

Subsequently, the terminal generates a data frame using the codes determined in step S3102 (step S3107). Thereafter, the terminal determines whether or not the data frame transmission time determined in step S3102 has come (step S3108).

When the data frame transmission time comes (Yes in step S3108), the terminal transmits a data frame at the frequency determined in step S3102 (step S3109), and ends the present process.

For example, in the communication sequence presented in FIG. 29, it is assumed that each of the terminals 1 and 2 performs a transmission process for transmitting a control frame and a data frame in accordance with the processing procedure presented in FIG. 31.

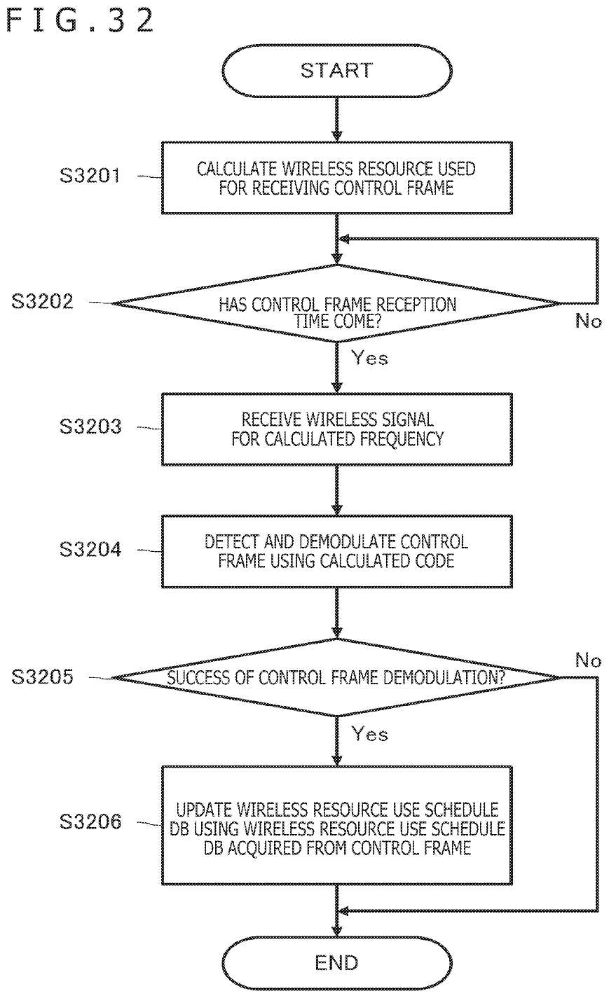

FIG. 32 presents a processing procedure in the form of a flowchart performed by a base station for receiving a control frame from a terminal. In this case, it is assumed that the base station has the device configuration depicted in FIG. 27.

Initially, the base station calculates a wireless resource (time, frequency, and codes) used for control frame reception (step S3201). It is difficult to recognize beforehand a time and a frequency of control frame transmission from a terminal located within a reception range of the base station. Accordingly, the base station basically performs a reception process constantly for all times (all time slots) and frequencies available for control frame transmission.

Subsequently, the base station calculates whether or not the control frame reception time calculated in step S3201 has come (step S3202).

Thereafter, when the control frame reception time comes (Yes in step S3202), the base station performs a reception process for receiving a wireless signal at the frequency calculated in step S3201 (step S3203).

Subsequently, the base station performs a process for detecting and demodulating the control frame using the codes calculated in step S3201 (step S3204). Then, the base station determines whether or not demodulation of the control frame has succeeded (step S3205).

In a case where demodulation of the control frame has succeeded (Yes in step S3205), the base station updates a wireless resource use schedule database managed by the storage unit 208 of the base station using wireless resource information scheduled to be used and acquired from the control frame (step S3206), and ends the present process.

Moreover, in a case where demodulation of the control frame has failed (No in step S3205), the base station ends the present process without updating the wireless resource use schedule database managed by the storage unit 208 of the base station.

For example, in the communication sequence presented in FIG. 29, it is assumed that the base station performs a reception process for receiving a control frame from the terminal and updates a wireless resource use schedule database in accordance with the processing procedure presented in FIG. 32.

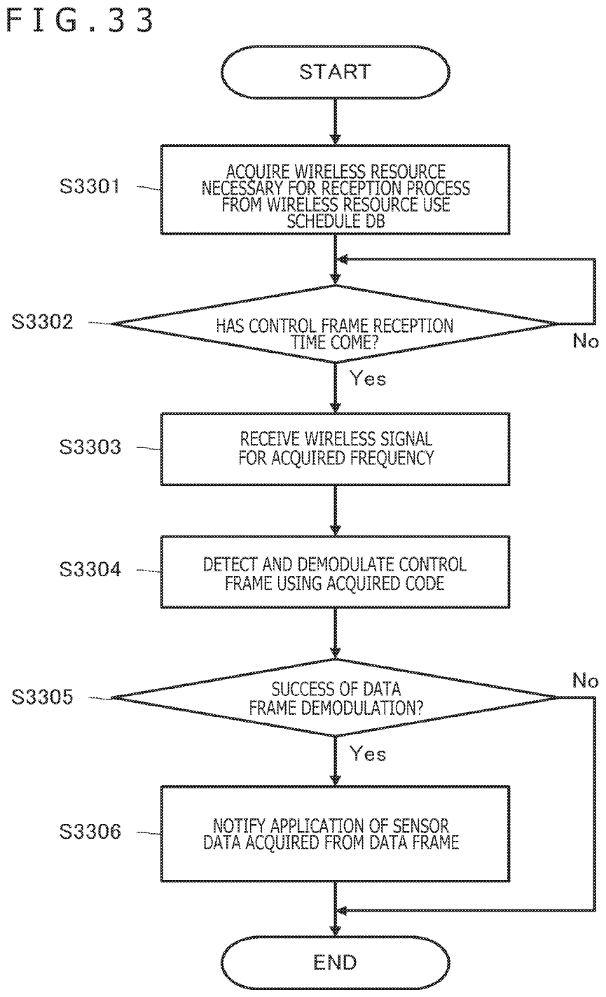

FIG. 33 presents a processing procedure in the form of a flowchart performed by a base station for receiving a data frame from a terminal. In this case, it is assumed that the base station has the device configuration depicted in FIG. 27.

Initially, the base station acquires a wireless resource (time, frequency, and codes) requiring a reception process from a wireless resource use schedule database managed by the storage unit 208 within the base station (step S3301).

Subsequently, the base station determines whether or not the data frame reception time acquired in step S3301 has come (step S3302).

Thereafter, when the data frame reception comes (Yes in step S3302), the base station performs a reception process for receiving a wireless signal at the frequency acquired in step S3301 (step S3303).

Subsequently, the base station performs a process for detecting and demodulating the data frame using the codes acquired in step S3301 (step S3304). Then, the base station determines whether or not demodulation of the data frame has succeeded (step S3305).

In a case where demodulation of the data frame has succeeded (Yes in step S3305), the base station notifies an upper layer application of sensor data acquired from the data frame (step S3306), and ends the present process.

On the other hand, in a case where demodulation of the data frame has failed (No in step S3305), the base station ends the present process without acquiring sensor data from the data frame.

For example, in the communication sequence presented in FIG. 29, it is assumed that the base station performs a reception process for receiving a data frame from each of the terminals 1 and 2 in accordance with the processing procedure presented in FIG. 33.

As described above, according to the present embodiment, each of the terminals within the wireless communication system shares information associated with wireless resources scheduled to be used by the respective terminals. In this manner, each of the terminals is capable of selecting a wireless resource allowing avoidance of a collision between a transmission frame of a terminal and a transmission frame of another terminal, or allowing separation even without the necessity of achieving time synchronization. Moreover, the base station is also capable of recognizing a wireless resource requiring a data frame reception process beforehand. Accordingly, efficient utilization of a calculation resource is achievable.

### Embodiment 5

A base station and a terminal are unable to recognize a wireless resource used by a terminal located outside receivable ranges of the base station and the terminal. Accordingly, in the fourth embodiment described above, a collision between frames transmitted from the respective terminals may be caused, or separation of the frames may be difficult to achieve.

Accordingly, proposed in a fifth embodiment is a method which allows a base station and a terminal to recognize a wireless resource used by a terminal located outside receivable ranges of the base station and the terminal by sharing a wireless resource use schedule database with each other using a control frame.

A frame configuration in the fifth embodiment is similar to the frame configuration of the fourth embodiment. FIG. 34 depicts a frame configuration example of a DATA portion of a control frame in the fifth embodiment. The DATA portion depicted in this figure includes respective fields of Code, Time, Length, and Database.

The Code field describes a code number uniquely representing a code of a wireless resource use schedule database transmitted by this control frame.

The Time field stores a beginning time of the wireless resource use schedule database transmitted by this control frame. This field describes an elapsed time from a time at which this control frame is transmitted.

The Length field stores information indicating a time length of the wireless resource use schedule database transmitted by this control frame.

The Database field stores the wireless resource use schedule database. In a case where the wireless resource use schedule database is too large to be transmitted by one control frame, the control frame may be divided into a plurality of parts and transmitted for each part.

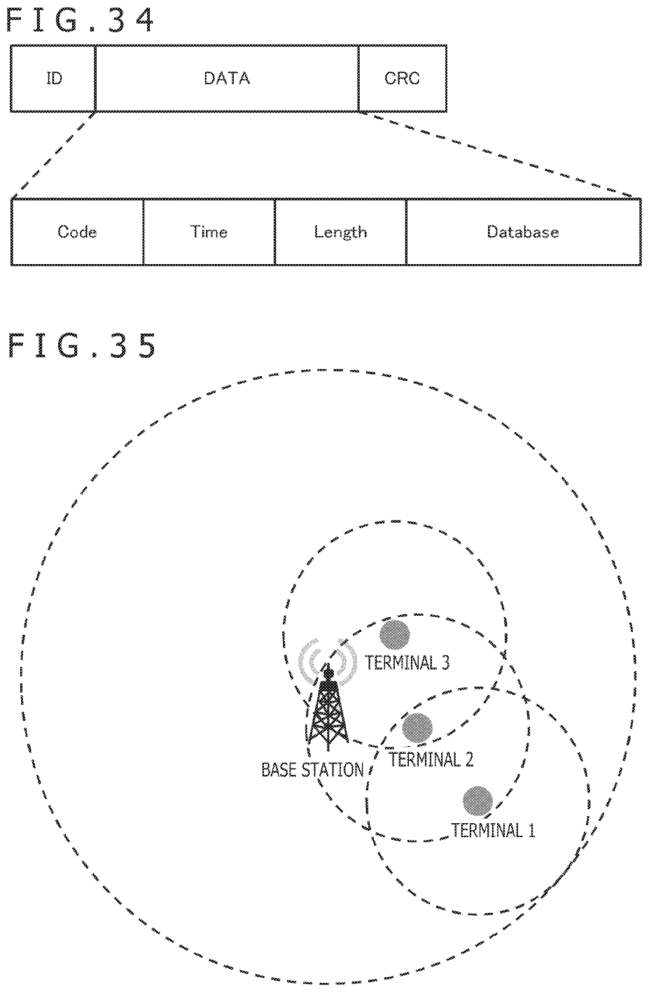

FIG. 35 depicts an example of a wireless communication system assumed in the fifth embodiment. The wireless communication system depicted in the figure includes one base station, and the terminal 1, the terminal 2, and a terminal 3 each present within a signal receivable range from the base station. In the figure, each of the receivable ranges of signals from the base station and the terminals 1, 2, and 3 is surrounded and indicated by a dotted line.

According to the configuration example of the wireless communication system depicted in FIG. 35, the terminal 3 is located outside a receivable range of the terminal 1, while the terminal 2 is located inside the receivable range of the terminal 1. In addition, the terminal 3 is located inside a receivable range of the terminal 2. Accordingly, the terminal 2 is capable of acquiring wireless resource information scheduled to be used by the terminal 3 from a control frame received from the terminal 3. Moreover, the terminal 1 is capable of acquiring the wireless resource information scheduled to be used by the terminal 3 from a control frame received from the terminal 2. Furthermore, the terminal 3 is similarly capable of acquiring wireless resource information scheduled to be used by the terminal 1 from a control frame received from the terminal 2.

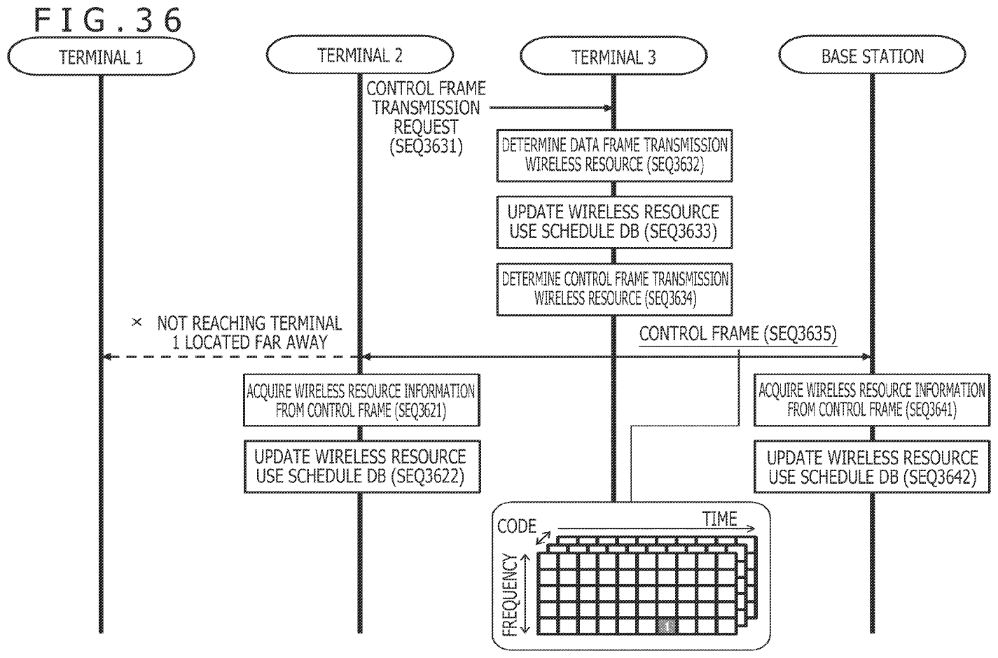

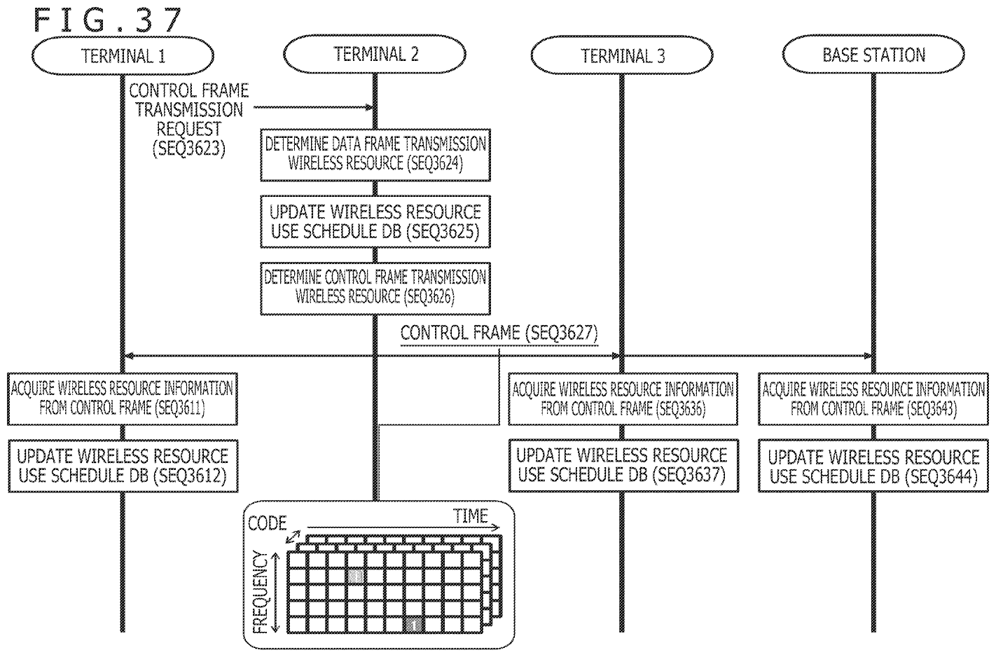

FIGS. 36 and 37 each depict a communication sequence example of the wireless communication system depicted in FIG. 35. In this case, it is assumed that each of the terminals 1, 2, and 3 has the device configuration depicted in FIG. 23, and that the base station has the device configuration depicted in FIG. 27.

In response to reception of a control frame transmission request from an upper layer (SEQ3631), the terminal 3 determines a wireless resource (time, frequency, and codes) used for data frame transmission (SEQ3632), and updates a wireless resource use schedule database (SEQ3633).

Subsequently, the terminal 3 determines a wireless resource (time, frequency, and codes) used for control frame transmission (SEQ3634). The terminal 3 selects any transmission time, and any frequency from frequencies available for control frame transmission, and determines codes using pseudorandom number generators. Thereafter, the terminal 3 transmits, using the determined wireless resource, a control frame containing the wireless resource use schedule database obtained after update (SEQ3635).

The terminal 3 transmits the control frame by broadcasting. Accordingly, the control frame transmitted by the terminal 3 is received by the base station and the terminal 2 located within the receivable range but does not reach the terminal 1 located far away outside the receivable range.

The base station having received the control frame from the terminal 3 receives and demodulates the control frame, acquires wireless resource information stored in the control frame (SEQ3641), and updates a wireless resource use schedule database managed by the storage unit 208 of the base station (SEQ3642).

Moreover, the terminal 2 having received the control frame from the terminal 3 also receives and modulates the control frame, acquires the wireless resource information stored in the control frame (SEQ3621), and updates a wireless resource use schedule database managed by the storage unit 111 of the terminal 2 (SEQ3622).

Thereafter, the terminal 3 transmits a data frame at the frequency and the codes determined above when the determined data frame transmission start time comes. Moreover, the base station performs a reception process for receiving the data frame from the terminal 3 on the basis of the wireless resource use schedule database (not presented in FIG. 36).

Furthermore, in response to reception of a control frame transmission request from the upper layer (SEQ3623), the terminal 2 determines a wireless resource (time, frequency, and codes) used for data frame transmission (SEQ3624), and updates a wireless resource use schedule database (SEQ3625).

Subsequently, the terminal 2 determines a wireless resource (time, frequency, and codes) used for data frame transmission (SEQ3626). The terminal 2 selects any transmission time, and any frequency from frequencies available for control frame transmission, and determines codes using pseudorandom number generators. Thereafter, the terminal 2 transmits, using the determined wireless resource, a control frame containing the wireless resource use schedule database obtained after update (SEQ3627).

The terminal 2 transmits the control frame by broadcasting. Accordingly, the control frame transmitted by the terminal 2 is received by the base station and the terminals 1 and 3 located within the receivable range.

The base station having received the control frame from the terminal 2 receives and demodulates the control frame, acquires wireless resource information stored in the control frame (SEQ3643), and updates a wireless resource use schedule database managed by the storage unit 208 of the base station (SEQ3644).

Moreover, the terminal 1 having received the control frame from the terminal 2 receives and modulates the control frame, acquires wireless resource information stored in the control frame (SEQ3611), and updates a wireless resource use schedule database managed by the storage unit 111 of the terminal 1 (SEQ3612).

Moreover, the terminal 3 having received the control frame from the terminal 2 also receives and modulates the control frame, acquires wireless resource information stored in the control frame (SEQ3636), and updates a wireless resource use schedule database managed by the storage unit 111 of the terminal 3 (SEQ3637).

Thereafter, the terminal 2 transmits a data frame at the frequency and the codes determined above when the determined data frame transmission start time comes. Moreover, the base station performs a reception process for receiving a data frame from the terminal 3 on the basis of the wireless resource use schedule database (not presented in FIG. 36).

As described above, according to the present embodiment, each of the base station and the terminals within the wireless communication system is also capable of recognizing a wireless resource used by a terminal located outside the receivable range of the base station and the terminals by sharing the wireless resource use schedule database with each other.

### Embodiment 6

According to the fifth embodiment described above, inconsistency may be caused between terminals depending on update timing in a process of sequentially sharing the wireless resource use schedule database within the wireless communication system.

Accordingly, proposed in a sixth embodiment is a method which repairs inconsistency between terminals in a short period of time by sharing a wireless resource use schedule database between the terminals using a DL beacon frame transmitted from a base station.

A terminal operating in a wireless communication system according to the sixth embodiment may have a configuration similar to that of the fourth embodiment, i.e., the device configuration depicted in FIG. 23. However, it is assumed that the frame detection unit 105 and the frame demodulation unit 106 perform detection and demodulation processes, respectively, for a DL beacon frame transmitted from the base station in addition to these processes for a control frame transmitted from another terminal.

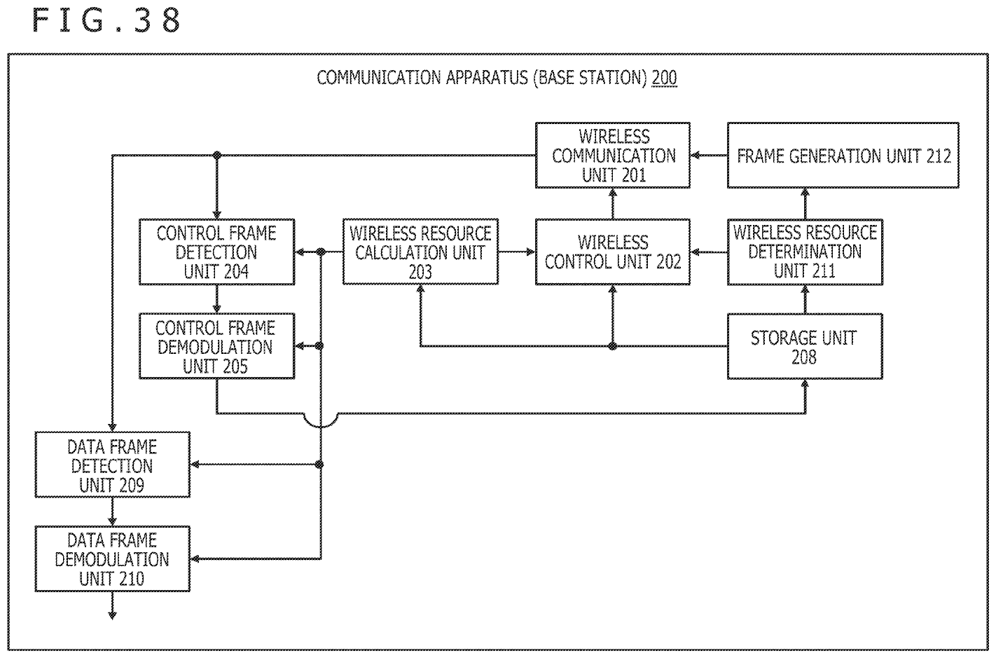

FIG. 38 depicts a configuration example of the communication apparatus 200 operating as a base station in the wireless communication system according to the sixth embodiment. For example, it is assumed that the communication apparatus 200 performs an operation for receiving a data frame containing sensor data from each of sensor terminals in the wireless sensor network. The communication apparatus 200 depicted in the figure includes the wireless communication unit 201, the wireless control unit 202, the wireless resource calculation unit 203, the control frame detection unit 204, the control frame demodulation unit 205, the storage unit 208, the data frame detection unit 209, the data frame demodulation unit 210, the wireless resource determination unit 211, and the frame generation unit 212.

The wireless communication unit 201 transmits and receives a wireless signal. During transmission, the wireless communication unit 201 converts a frame generated by the frame generation unit 212 into a wireless signal and transmits the wireless signal under control by the wireless control unit 202. Moreover, the wireless communication unit 201 receives a radio wave and converts the radio wave into a wireless signal under control by the wireless control unit 202. In a case where an instruction from the wireless control unit 202 is reception of a control frame, the wireless communication unit 201 passes a reception signal to the control frame detection unit 204. In a case where an instruction from the wireless control unit 202 is reception of a data frame, the wireless communication unit 201 passes a reception signal to the data frame detection unit 209.

The frame generation unit 212 generates a DL beacon frame using codes determined by the wireless resource determination unit 211. The wireless resource determination unit 211 determines a time, a frequency, and codes (SYNC code and scramble code) at which a DL beacon frame is transmitted, on the basis of information stored in the storage unit 208.

The wireless control unit 202 controls the wireless communication unit 201 in such a manner as to receive a control frame and a data frame at a reception time and a reception frequency obtained by the wireless resource determination unit 211.

Furthermore, the wireless control unit 202 controls the wireless communication unit 201 in such a manner as to transmit a DL beacon frame at a transmission time and a transmission frequency obtained by the wireless resource determination unit 211.

The wireless resource determination unit 211 determines a wireless resource (time, frequency, and codes) used for DL beacon frame transmission on the basis of a wireless resource use schedule database stored in the storage unit 208, and calculates a time, a frequency, and codes (SYNC code and scramble code) at which a control frame and a data frame are transmitted from each of the terminals within the wireless communication system.

The wireless resource calculation unit 203 calculates a time, a frequency, and codes (SYNC code and scramble code) at which a control frame, and a data frame of a terminal whose terminal ID has been registered beforehand are transmitted. The wireless resource calculation unit 203 calculates the time, the frequency, and the codes by using methods different for each of the control frame and the data frame (described above).

The control frame detection unit 204 extracts a signal at a targeted frequency from a broadband signal, generates a known sequence from a SYNC code and a scramble code calculated by the wireless resource calculation unit 203, calculates a correlation value between the known sequence and a reception signal, and determines that a control frame has been detected in a case where the correlation value becomes a fixed value or larger. The control frame detection unit 204 passes the detected time to the control frame demodulation unit 205 in a case where detection of a control frame has succeeded.

The control frame demodulation unit 205 cancels scrambling using a scramble code calculated by the wireless resource calculation unit 203, on the basis of a time detected by the control frame detection unit 204. Thereafter, the control frame demodulation unit 205 extracts a payload portion of the received frame, and performs a demodulation process for demodulating an error correction code, and an error detection process using CRC.

The data frame detection unit 209 extracts a signal at a targeted frequency from a broadband signal, generates a known sequence from a SYNC code and a scramble code calculated by the wireless resource calculation unit 203, calculates a correlation value between the known sequence and a reception signal, and determines that a data frame has been detected in a case where the correlation value becomes a fixed value or larger. The data frame detection unit 209 passes the detected time to the data frame demodulation unit 210 in a case where detection a data frame has succeeded.

The data frame demodulation unit 210 cancels scrambling using a scramble code calculated by the wireless resource calculation unit 203 on the basis of the time detected by the data frame detection unit 209. Thereafter, the data frame demodulation unit 210 extracts a payload portion of the received frame and performs a demodulation process for demodulating an error correction code, and an error detection process using CRC. Subsequently, in a case where demodulation of a data frame has succeeded, the data frame demodulation unit 210 notifies an upper layer application or the like of reception data such as sensor data contained in the data frame.

Subsequently described will be a wireless resource determination method used for DL beacon frame transmission in the present embodiment.

Concerning a time, the base station regularly transmits a DL beacon frame at any time.

Moreover, concerning a frequency, the base station transmits a DL beacon frame at all frequencies available for DL beacon frame transmission.

Moreover, it is assumed that a SYNC code and a scramble code used for DL beacon frame transmission are common codes within the wireless communication system. The SYNC code and the scramble code are generated by pseudorandom number generators (see FIGS. 6 and 7) each including a gold code generator using two M sequences similarly to a control frame and a data frame. Initial values 1 to 4 set in a DL beacon frame are values within the wireless communication system, and retained in the storage unit 208 and determined beforehand.

A frame configuration in the sixth embodiment is similar to the frame configuration of the fifth embodiment. Moreover, a configuration of a DATA portion of a DL beacon frame is similar to the configuration of a control frame in the fifth embodiment. Furthermore, an ID field of a DL beacon frame stores an identifier of the base station corresponding to a transmission source.

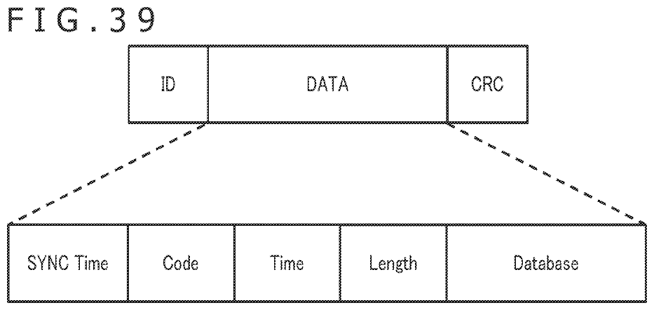

FIG. 39 depicts a frame configuration example of the DATA portion of the DL beacon frame in the sixth embodiment. The DATA portion depicted in this figure includes respective fields of SYNC Time, Code, Time, Length, and Database.

The SYNC Time field describes information regarding a time synchronized with a wireless resource use schedule database stored in the DL beacon frame.

The Code field describes a code number uniquely representing a code of a wireless resource use schedule database transmitted by this control frame.

The Time field stores a beginning time of a wireless resource use schedule database transmitted by this control frame. This field describes an elapsed time from a time at which this control frame is transmitted.

The Length field stores information indicating a time length of the wireless resource use schedule database transmitted by this control frame.

The Database field stores a wireless resource use schedule database. In a case where the wireless resource use schedule database is too large to be transmitted by one DL beacon frame, the DL beacon frame may be divided into a plurality of parts and transmitted for each part.

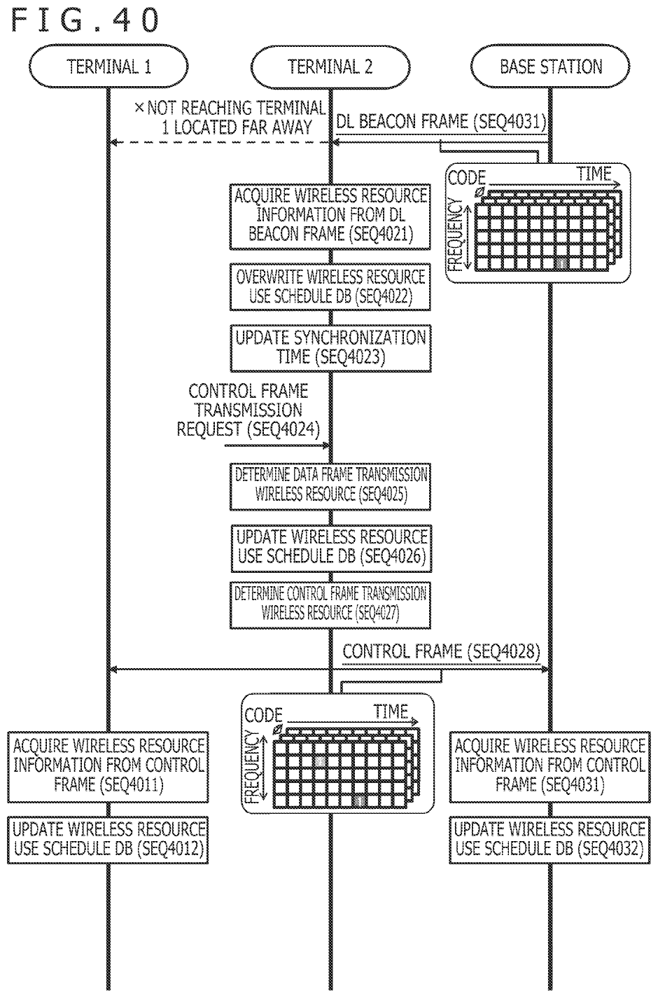

FIG. 40 depicts a communication sequence example of the wireless communication system according to the present embodiment. Assumed here is the configuration of the wireless communication system depicted in FIG. 14. In this case, it is assumed that each of the terminals 1 and 2 has the device configuration depicted in FIG. 23, and that the base station has the device configuration depicted in FIG. 38.

The base station regularly transmits a DL beacon frame (see FIG. 39) storing a wireless resource use schedule database at any time and at all transmittable frequencies (SEQ4031). The DL beacon frame transmitted by the base station is received by the base station and the terminal 2 located within the receivable range but does not reach the terminal 1 located far away outside the receivable range.

When the terminal 2 acquires wireless resource information from the DL beacon frame received from the base station (SEQ4021), the terminal 2 overwrites a wireless resource use schedule database managed by the storage unit 111 of the terminal 2 (SEQ4022), and updates a synchronization time on the basis of time information stored in the DL beacon frame (SEQ4023).

Thereafter, in response to reception of a control frame transmission request from an upper layer (SEQ4024), the terminal 2 determines a wireless resource (time, frequency, and codes) used for data frame transmission in accordance with the processing procedure presented in FIGS. 28A and 28B, for example, with reference to the wireless resource use schedule database (SEQ4025), and updates the wireless resource use schedule database managed by the storage unit 111 of the terminal 2 (SEQ4026).

Subsequently, the terminal 2 determines a wireless resource (time, frequency, and codes) used for control frame transmission (SEQ4027). As described above, the terminal 2 selects any transmission time, and any frequency from frequencies available for control frame transmission, and determines codes using pseudorandom number generators. Thereafter, the terminal 2 transmits, by using the determined wireless resource, a control frame storing the wireless resource use schedule database (SEQ4028).

The terminal 2 transmits the control frame by broadcasting. Accordingly, the control frame transmitted from the terminal 2 is received by both the base station and the terminal 1.

The base station having received the control frame from the terminal 2 receives and demodulates the control frame, acquires information associated with a transmission start time, a frequency, and codes of a data frame used by the terminal 2 and stored in the control frame (SEQ4031), and updates a wireless resource use schedule database managed by the storage unit 208 of the base station (SEQ4032).

Moreover, the terminal 1 having received the control frame from the terminal 2 also receives and demodulates the control frame, acquires information associated with a transmission start time, a frequency, and codes of a data frame used by the terminal and stored in the control frame (SEQ4011), and updates a wireless resource use schedule database managed by the storage unit 111 of the terminal 1 (SEQ4012).

Thereafter, the terminal 2 transmits a data frame using the frequency and the codes determined above when the determined data frame transmission start time comes. Moreover, the base station performs a reception process for receiving a data frame from the terminal 3 on the basis of the wireless resource use schedule database (not presented in FIG. 40).

Furthermore, while not depicted in FIG. 40, it is assumed that the terminal 1 also determines a wireless resource to be used for data frame transmission, updates a wireless resource use schedule database, determines a wireless resource to be used as a transmission resource of a control frame, and transmits a control frame, and then transmits a data frame at the determined wireless resources in response to a control frame transmission request from the upper layer.

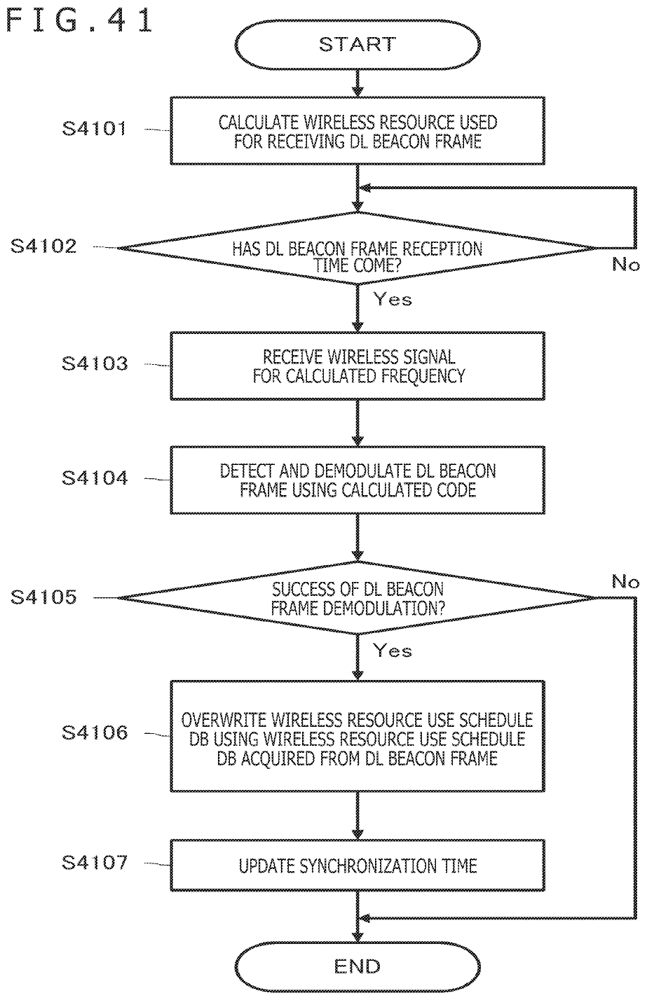

FIG. 41 presents a processing procedure in the form of a flowchart for synchronizing a wireless resource use schedule database by a terminal using a DL beacon frame received from a base station. In this case, it is assumed that the terminal has the device configuration depicted in FIG. 23.

Initially, the terminal calculates a wireless resource (time, frequency, and codes) used for DL beacon frame reception (step S4101). The base station regularly transmits a DL beacon frame at all available frequencies (described above). Accordingly, the terminal may perform a reception process either for any one selected frequency, or for all frequencies for a certain period of time.

Subsequently, the terminal determines whether or not the DL beacon frame reception time calculated in step S4101 has come (step S4102).

Thereafter, when the DL beacon frame reception time comes (Yes in step S4102), the terminal performs a reception process for receiving a wireless signal at the frequency calculated in step S4101 (step S4103).

Subsequently, the terminal performs a process for detecting and demodulating a DL beacon frame using the code calculated in step S4101 (step S4104). Then, the terminal determines whether or not demodulation of the DL beacon frame has succeeded (step S4105).

In a case where demodulation of the DL beacon frame has succeeded (Yes in step S3205), the terminal overwrites a wireless resource use schedule database managed by the storage unit 111 of the terminal using wireless resource information scheduled to be used and acquired from the DL beacon frame (step S4106), and further updates a synchronization time (step S4107) and ends the present process.

Moreover, in a case where demodulation of the DL beacon frame has failed (No in step S4105), the terminal ends the present process without overwriting the wireless resource use schedule database managed by the storage unit 111 of the terminal and updating time synchronization.

For example, in the communication sequence presented in FIG. 40, it is assumed that the terminal 2 performs a synchronization process for a wireless resource use schedule database using a DL beacon frame received from the base station in accordance with the processing procedure presented in FIG. 41.

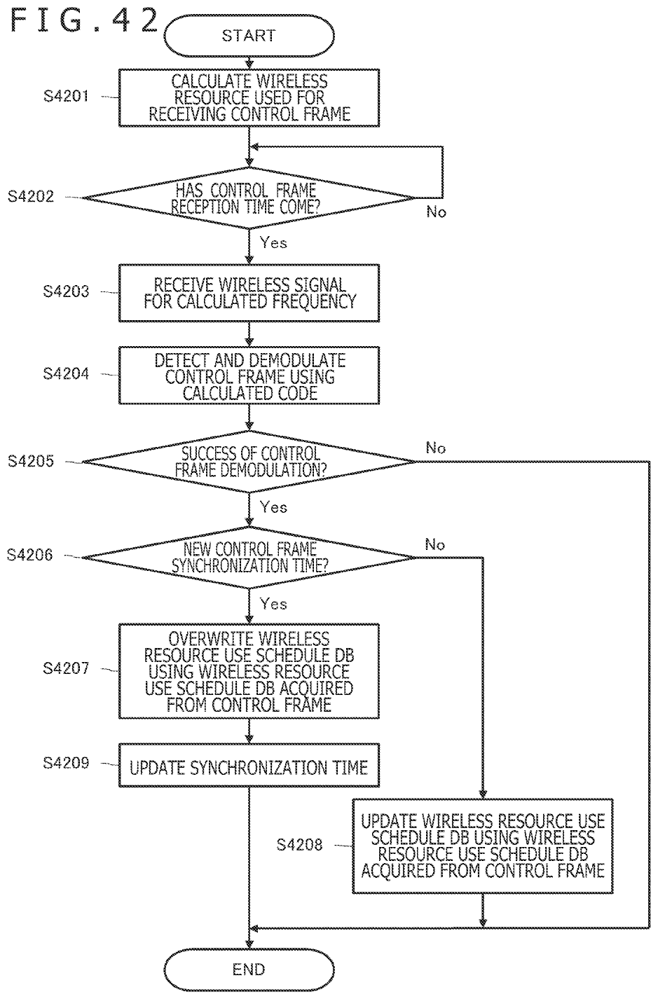

FIG. 42 presents a processing procedure in the form of a flowchart performed by a terminal for receiving a control frame from another terminal.

Initially, a wireless resource (time, frequency, and codes) to be used for control frame reception is calculated (step S4201). It is difficult to recognize beforehand a time and a frequency at which a control frame is transmitted from another terminal located within a reception range of the terminal. Accordingly, the terminal basically performs a reception process constantly for all times (all time slots) and frequencies available for control frame transmission.

Subsequently, it is determined whether or not the control frame reception time calculated in step S4201 has come (step S4202). Thereafter, when the control frame reception time comes (Yes in step S4202), the terminal performs a reception process for receiving a wireless signal at the frequency calculated in step S4201 (step S4203).

Subsequently, the terminal performs a process for detecting and demodulating a control frame using the codes calculated in step S4201 (step S4204). Then, the terminal determines whether or not demodulation of the control frame has succeeded (step S4205).

In a case where demodulation of the control frame has succeeded (Yes in step S4205), the terminal subsequently determines whether or not a synchronization time acquired from the control frame is newer than a synchronization time of a wireless resource use schedule database of the terminal (step S4206).

Thereafter, in a case where the synchronization time acquired from the control frame is newer than the synchronization time of the own wireless resource use schedule database (Yes in step S4206), the terminal overwrites the wireless resource use schedule database using wireless resource information scheduled to be used and acquired from the control frame (step S4207), and further updates the synchronization time (step S4209) and ends the present process.

On the other hand, in a case where the synchronization time acquired from the control frame is older than the synchronization time of the own wireless resource use schedule database (No in step S4206), the terminal updates the wireless resource use schedule database using the wireless resource information scheduled to be used and acquired from the control frame (step S4208), and ends the present process without updating the synchronization time.

Note that “update” here refers to a process performed for a wireless resource which is in an unused state in the (new) wireless resource use schedule database retained by the terminal and scheduled to be used in the (old) wireless resource use schedule database acquired from a control frame to switch the wireless resource schedule database retained by the terminal to a state of use schedule. The terminal avoids a collision as much as possible by switching to use schedule on the basis of the old wireless resource use schedule database acquired from a control frame of another terminal. Meanwhile, “overwrite” here refers to, in addition to the “update” process described above, a process performed for a wireless resource which is scheduled to be used in the (old) wireless resource use schedule database retained by the terminal and in an unused state in the (new) wireless resource use schedule database acquired from a control frame to return the wireless resource schedule database held by the terminal to the unused state. This process is performed because returning to the unused state on the basis of new information causes no collision, and achieves efficient utilization by releasing the wireless resource.

Moreover, in a case where demodulation of the control frame has failed (No in step S4205), the terminal ends the present process without overwriting or updating the wireless resource use schedule database managed by the storage unit 111 of the terminal, and without updating synchronization time.

For example, in the communication sequence presented in FIG. 40, it is assumed that the terminal 1 performs a synchronization process for a wireless resource use schedule database using a control frame received from the terminal 2 in accordance with the processing procedure presented in FIG. 42.

A processing procedure performed by the base station for transmitting a DL beacon frame is similar to the corresponding processing procedure in the second embodiment described above (see FIG. 20). Accordingly, detailed description is omitted herein.

As described above, according to the present embodiment, the wireless resource use schedule database retained by the base station able to receive control frames and data frames from all terminals within the wireless communication system and performing a reception process for receiving data frames is shared as a master within the wireless communication system using a DL beacon frame transmitted from the base station. In this manner, even in a case of inconsistency of wireless resource information between terminals, this inconsistency can be repaired within a short period of time such as a beacon transmission period.

### Embodiment 7

According to the fourth embodiment described above, the terminal gives, by using a control frame, a notification of a wireless resource used by a data frame to be transmitted next. It is therefore assumed that one data frame is transmitted for each control frame.

However, in this communication procedure, there arises a problem that the number of times of control frame transmission increases. Moreover, in a case of a failure of control frame reception by a base station, there is produced such a disadvantage that a wireless resource used for data frame transmission is unknown.

Accordingly, proposed in a seventh embodiment is a method which reduces the number of times of control frame transmission by reserving beforehand a wireless resource of a data frame regularly transmitted from a terminal.

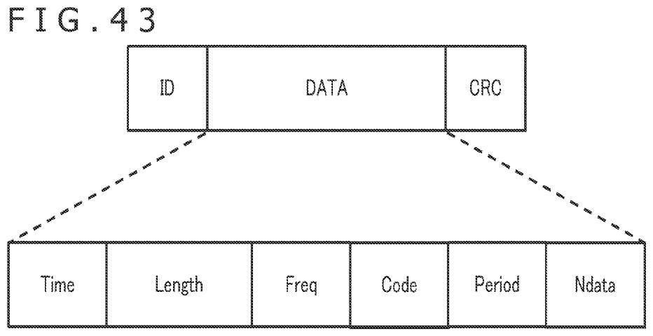

A frame configuration in the seventh embodiment is similar to the frame configuration of the fourth embodiment. FIG. 43 depicts a frame configuration example of a DATA portion of a control frame in the seventh embodiment. The DATA portion depicted in this figure includes respective fields of Time, Length, Freq, Code, Period, and Ndata.

The Time field stores a data frame transmission start time. This field describes an elapsed time from a time of transmission of a corresponding control frame as information indicating a data frame transmission start time. Moreover, the Length field stores information indicating a data frame time length. Further, the Freq field stores a frequency channel number uniquely representing a data frame transmission frequency. In addition, the Code field stores a code number uniquely representing a code used for data frame transmission.

The Period field stores information indicating a data frame transmission period. Moreover, the Ndata field stores information indicating the number of times of data frame transmission using a wireless resource (frequency and codes) given by a notification using the corresponding control frame.

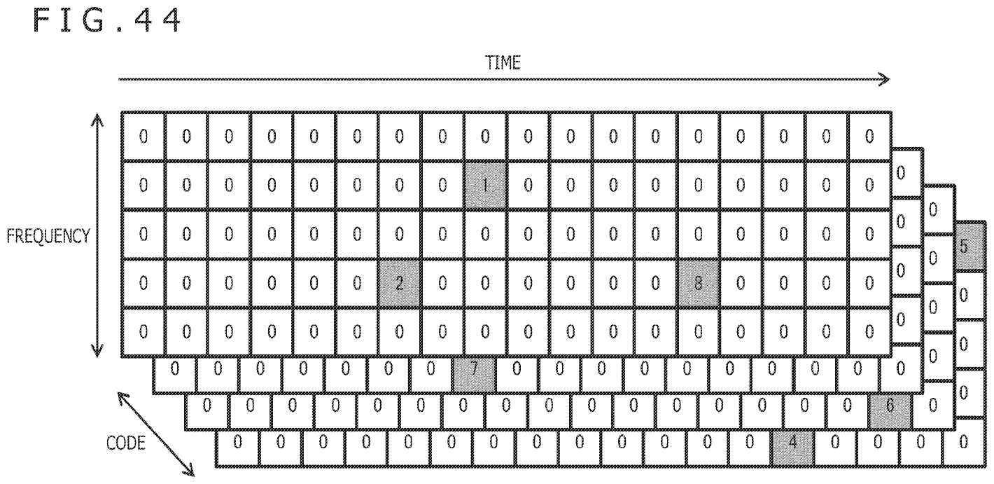

FIG. 44 depicts a configuration example of a wireless resource use schedule database according to the present embodiment. In this figure, a horizontal axis represents a time axis, a vertical axis represents a frequency axis, and a code axis is set in a depth direction. The wireless resource use schedule database is a list of wireless resources (time, frequency, and codes) available for data frame transmission, and similar to the corresponding list in the fourth embodiment in the point that the value “0” is retained for a wireless resource not scheduled to be used but is different in the point that the terminal retains a corresponding terminal ID for a wireless resource which is a vessel used by the terminal.

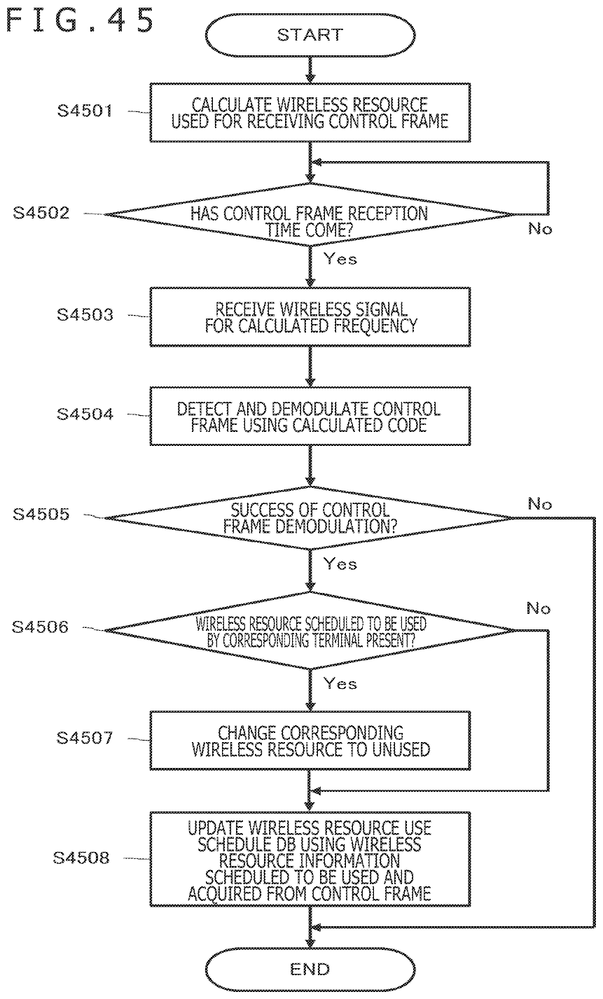

FIG. 45 presents a processing procedure in the form of a flowchart performed by a base station for receiving a control frame from a terminal. In this case, it is assumed that the base station has the device configuration depicted in FIG. 27.

Initially, the base station calculates a wireless resource (time, frequency, and codes) used for control frame reception (step S4501). It is difficult to recognize beforehand a time and a frequency of control frame transmission from a terminal located within a reception range of the base station. Accordingly, the base station basically performs a reception process for all times (all time slots) and frequencies available for control frame transmission.

Subsequently, the base station calculates whether or not the control frame reception time determined in step S4501 has come (step S4502).

Thereafter, when the control frame reception time comes (Yes in step S4502), the base station performs a reception process for receiving a wireless signal at the frequency calculated in step S4501 (step S4503).

Subsequently, the base station performs a process for detecting and demodulating a control frame using the codes calculated in step S4501 (step S4504). Then, the base station determines whether or not demodulation of the control frame has succeeded (step S4505).

In a case where demodulation of the control frame has succeeded (Yes in step S4505), the base station further determines whether or not a wireless resource scheduled to be used by the corresponding terminal is present after a data frame transmission start time acquired from the control frame (step S4506).

In a case where a wireless resource scheduled to be used by the corresponding terminal is present after the data frame transmission start time acquired from the control frame (Yes in step S4506), the base station switches a state of the corresponding wireless resource to an unused state (step S4507). On the other hand, in a case where a wireless resource scheduled to be used by the corresponding terminal is absent after the data frame transmission start time acquired from the control frame (No in step S4506), the base station does not switch the state of the corresponding wireless resource to the unused state.

Thereafter, the base station updates a wireless resource use schedule database by using wireless resource information scheduled to be used and acquired from the control frame (step S4508), and ends the present process.

Moreover, in a case where demodulation of the control frame has failed (No in step S4505), the base station ends the present process without switching the wireless resource and updating the wireless resource use schedule database.

As described above, according to the present embodiment, the terminal need not give a notification of a wireless resource to be used “by using a control frame” until completion of transmission of a data frame by the number of times of data frame transmission given by a notification using a control frame. Accordingly, reduction of the number of times of transmission of a control frame is achievable by reserving beforehand a wireless resource of a data frame regularly transmitted from the terminal. In a case where a change of a wireless resource used by the terminal is desired on the basis of wireless resource information contained in a control frame received from a near station, the terminal is capable of giving a notification using a control frame to change the wireless resource immediately.

In addition, summarizing the first to seventh embodiments, information necessary for determining a wireless resource used for data frame transmission is acquired using a control frame transmitted from a near terminal in an asymmetric wireless communication system where a receivable range of a base station is different from a receivable range of a terminal. In this manner, even a terminal located at a place at which DL communication is difficult to achieve is capable of autonomously selecting a wireless resource allowing avoidance of a collision with a data frame transmitted from another terminal, or allowing separation.

### INDUSTRIAL APPLICABILITY

The technology disclosed in the present specification has been described hereinabove in detail with reference to the specific embodiments. However, it is apparent that those skilled in the art are allowed to make corrections and substitutions for the embodiments without departing from subject matters of the technology disclosed in the present specification.

While the embodiments each applying the technology disclosed in the present specification to a wireless sensor network have mainly been presented in the present specification, the subject matters of the technology disclosed in the present specification are not limited to these embodiments. Each of terminals is capable of estimating a wireless resource allowing avoidance of a collision with another terminal and allowing separation, and autonomously determining a wireless resource used for frame transmission by similarly applying the technology disclosed in the present specification to various types of wireless communication system assumed to have a considerably large number of terminals, or various types of wireless communication system easily causing collisions with transmission frames from other terminals.

Moreover, while the embodiments each associated with an asymmetric wireless communication system where a receivable range of a base station is different from a receivable range of a terminal have mainly been described in the present specification, the application range of the technology disclosed in the present specification is not limited to the asymmetric communication system.

In short, while the technology disclosed in the present specification has been presented by way of example, it is not intended that contents presented in the present specification be interpreted in a limited manner. The claims should be taken into consideration to determine the subject matters of the technology disclosed in the present specification.

Note that the technology disclosed in the present specification may also have following configurations.

(1)

A communication apparatus including:

a communication unit that transmits and receives a wireless signal; and

a control unit that controls frame transmission and reception performed by the communication unit,

in which the control unit performs such a control as to give, using a control frame, a notification of information associated with a wireless resource to be used for transmission of a data frame.

(1-1)

The communication apparatus according to (1) described above,

in which the wireless resource includes at least one of a data frame transmission time, a data frame transmission frequency, and a data frame coding system.

(2)

The communication apparatus according to (1) described above,

in which the control unit performs such a control as to transmit a control frame that contains the information including time information to be used for time synchronization.

(2-1)

The communication apparatus according to (2) described above,

in which the control unit performs such a control as to give a notification of the information that contains time information acquired from an external signal.

(2-2)

The communication apparatus according to (2-1) described above,

in which the external signal contains at least one of a GPS signal and a beacon signal.

(3)

The communication apparatus according to (1) or (2) described above,

in which the control unit performs such a control as to transmit a control frame that further contains the information associated with a transmission time of the data frame.

(4)

The communication apparatus according to (3) described above,

in which the information associated with the wireless resource includes information associated with a transmission request time of the data frame and a transmission period of the data frame.

(5)

The communication apparatus according to any one of (1) to (4) described above,

in which the control unit performs such a control as to transmit a control frame that further contains the information indicating a wireless resource to be used for transmission of the data frame.

(6)

The communication apparatus according to (5) described above,

in which the control unit performs such a control as to transmit a control frame that contains the information indicating a transmission start time of the data frame, a time length of the data frame, a transmission frequency of the data frame, and a transmission start time of the data frame.

(7)

The communication apparatus according to any one of (1) to (6) described above,

in which the control unit performs such a control as to transmit a control frame that contains the information indicating a wireless resource to be used for transmission of the data frame, and a wireless resource used by another terminal for transmission of a data frame.

(8)

The communication apparatus according to any one of (1) to (7) described above,

in which the control unit performs such a control as to transmit a control frame that contains the information indicating a wireless resource to be used for transmission of the data frame, and a wireless resource used by another terminal for transmission of a data frame, and information associated with synchronization time of the information.

(9)

The communication apparatus according to any one of (1) to (8) described above,

in which the control unit performs such a control as to transmit a control frame that further contains information associated with a transmission period of the data frame, and number of times of transmission of the data frame using the wireless resource indicated by the control frame.

(10)

A communication method including:

a step of transmitting a control frame containing information associated with a wireless resource to be used for transmission of a data frame; and

a step of transmitting the data frame using the wireless resource.

(11)

A communication apparatus including:

a communication unit that transmits and receives a wireless signal; and

a control unit that controls frame transmission and reception performed by the communication unit,

in which the control unit acquires, from a received control frame, information associated with a wireless resource used by a transmission source of the control frame for transmission of a data frame, and determines a wireless resource to be used for transmission of the data frame.

(12)

The communication apparatus according to (11) described above,

in which the control unit acquires the information that includes time information to be used for time synchronization from the received control frame, and determines the wireless resource to be used for transmission of the data frame, on the basis of an obtained time.

(13)

The communication apparatus according to (11) or (12) described above,

in which the control unit determines the wireless resource to be used for transmission of the data frame in such a manner that the wireless resource does not overlap with a wireless resource used by another terminal for transmission of a data frame and contained in the received control frame as the information.

(14)

A communication method including:

a step of receiving a control frame containing information associated with a wireless resource to be used for transmission of a data frame; and

a step of determining the wireless resource to be used for transmission of the data frame, on the basis of the information acquired from the control frame, and transmits the data frame.

(15)

A communication apparatus including:

a communication unit that transmits and receives a wireless signal; and

a control unit that controls frame transmission and reception performed by the communication unit,

in which the control unit acquires, from a received control frame, information associated with a wireless resource to be used for transmission of a data frame by a second terminal having transmitted the control frame, and determines a wireless resource for which a reception process for receiving the data frame from the second terminal is performed.

(16)

The communication apparatus according to (15) described above,

in which the control unit acquires the information that includes time information to be used for time synchronization from the received control frame, and determines a wireless resource for which a reception process for receiving a data frame from another station is performed on the basis of an obtained time.

(17)

The communication apparatus according to (15) or (16) described above,

in which the control unit determines a wireless resource for which a reception process for receiving a data frame is performed on the basis of a wireless resource contained in a received control frame as the information and used by a third terminal for transmission of a data frame.

(18)

A communication method including:

a step of receiving a control frame containing information associated with a wireless resource to be used for transmission of a data frame; and

a step of performing a reception process for receiving the data frame, on the basis of the information acquired from the control frame.

### REFERENCE SIGNS LIST

100: Communication apparatus (terminal)
101: Wireless communication unit
102: Frame generation unit
103: Wireless control unit
104: Wireless resource determination unit
105: Frame detection unit
106: Frame demodulation unit
107: Terminal ID storage unit
108: Internal clock
109: GPS reception unit
110: Sensor
111: Storage unit
112: Wireless resource calculation unit
200: Communication apparatus (base station)
201: Wireless communication unit
202: Wireless control unit
203: Wireless resource calculation unit
204: Control frame detection unit
205: Control frame demodulation unit
206: Internal clock
207: GPS reception unit
208: Storage unit
209: Data frame detection unit
210: Data frame demodulation unit
212: Frame generation unit

1. A communication apparatus comprising:
a communication unit that transmits and receives a wireless signal; and
a control unit that controls frame transmission and reception performed by the communication unit,
wherein the control unit performs such a control as to give, using a control frame, a notification of information associated with a wireless resource to be used for transmission of a data frame.

2. The communication apparatus according to claim 1,
wherein the control unit performs such a control as to transmit a control frame that contains the information including time information to be used for time synchronization.

3. The communication apparatus according to claim 1,
wherein the control unit performs such a control as to transmit a control frame that further contains the information associated with a transmission time of the data frame.

4. The communication apparatus according to claim 3,
wherein the information associated with the wireless resource includes information associated with a transmission request time of the data frame and a transmission period of the data frame.

5. The communication apparatus according to claim 1, wherein
the control unit performs such a control as to transmit a control frame that further contains the information indicating a wireless resource to be used for transmission of the data frame.

6. The communication apparatus according to claim 5, wherein
the control unit performs such a control as to transmit a control frame that contains the information indicating a transmission start time of the data frame, a time length of the data frame, a transmission frequency of the data frame, and a transmission start time of the data frame.

7. The communication apparatus according to claim 1, wherein
the control unit performs such a control as to transmit a control frame that contains the information indicating a wireless resource to be used for transmission of the data frame, and a wireless resource used by another terminal for transmission of a data frame.

8. The communication apparatus according to claim 1, wherein
the control unit performs such a control as to transmit a control frame that contains the information indicating a wireless resource to be used for transmission of the data frame, and a wireless resource used by another terminal for transmission of a data frame, and information associated with synchronization time of the information.

9. The communication apparatus according to claim 1,
wherein the control unit performs such a control as to transmit a control frame that further contains information associated with a transmission period of the data frame, and number of times of transmission of the data frame using the wireless resource indicated by the control frame.

10. A communication method comprising:
a step of transmitting a control frame containing information associated with a wireless resource to be used for transmission of a data frame; and
a step of transmitting the data frame using the wireless resource.

11. A communication apparatus comprising:
a communication unit that transmits and receives a wireless signal; and
a control unit that controls frame transmission and reception performed by the communication unit,
wherein the control unit acquires, from a received control frame, information associated with a wireless resource used by a transmission source of the control frame for transmission of a data frame, and determines a wireless resource to be used for transmission of the data frame.

12. The communication apparatus according to claim 11,
wherein the control unit acquires the information that includes time information to be used for time synchronization from the received control frame, and determines the wireless resource to be used for transmission of the data frame, on a basis of an obtained time.

13. The communication apparatus according to claim 11,
wherein the control unit determines the wireless resource to be used for transmission of the data frame in such a manner that the wireless resource does not overlap with a wireless resource used by another terminal for transmission of a data frame and contained in the received control frame as the information.

14. A communication method comprising:
a step of receiving a control frame containing information associated with a wireless resource to be used for transmission of a data frame; and
a step of determining the wireless resource to be used for transmission of the data frame on a basis of the information acquired from the control frame, and transmits the data frame.

15. A communication apparatus comprising:
a communication unit that transmits and receives a wireless signal; and
a control unit that controls frame transmission and reception performed by the communication unit,
wherein the control unit acquires, from a received control frame, information associated with a wireless resource to be used for transmission of a data frame by a second terminal having transmitted the control frame, and determines a wireless resource for which a reception process for receiving the data frame from the second terminal is performed.

16. The communication apparatus according to claim 15,
wherein the control unit acquires the information that includes time information to be used for time synchronization from the received control frame, and determines a wireless resource for which a reception process for receiving a data frame from another station is performed on a basis of an obtained time.

17. The communication apparatus according to claim 15,
wherein the control unit determines a wireless resource for which a reception process for receiving a data frame is performed on a basis of a wireless resource contained in a received control frame as the information and used by a third terminal for transmission of a data frame.

18. A communication method comprising:
a step of receiving a control frame containing information associated with a wireless resource to be used for transmission of a data frame; and
a step of performing a reception process for receiving the data frame, on a basis of the information acquired from the control frame.
